(19) United States
(12) Patent Application Publication
(10) Pub. No.: US 2016/0124514 A1
(43) Pub. Date: May 5, 2016

(54) ELECTRONIC DEVICE AND METHOD OF CONTROLLING THE SAME

(71) Applicant: Samsung Electronics Co., Ltd., Gyeonggi-do (KR)

(72) Inventors: Hyeon-hee CHA, Gyeonggi-do (KR); Hye-sun KIM, Gyeonggi-do (KR); Su-jung BAE, Gyeonggi-do (KR); Seong-oh LEE, Gyeonggi-do (KR); Moon-sik JEONG, Gyeonggi-do (KR); Sung-do CHOI, Gyeonggi-do (KR); Hyun-soo CHOI, Seoul (KR)

(73) Assignee: Samsung Electronics Co., Ltd.

(21) Appl. No.: 14/933,754

(22) Filed: Nov. 5, 2015

(30) Foreign Application Priority Data
Nov. 5, 2014 (KR) 10-2014-0152856

(51) Int. Cl. G06F 3/01; G06F 3/0484; H04N 5/225; G06F 3/0482

(52) U.S. Cl. CPC G06F 3/017; G06F 3/0482; G06F 3/04842; H04N 5/225; G06F 3/04847

(57) ABSTRACT

A control method and an electronic device are provided. The electronic device includes a photographing unit configured to photograph a hand including fingers, a display unit configured to display a plurality of content objects, and a control unit configured to recognize a finger gesture of the photographed hand and a distance from the electronic device to the finger, and control the display unit to change and display a range of a displayed content object according to the recognized finger gesture and the distance.

### PRIORITY

This application claims priority under 35 U.S.C. §119(a) to Korean Patent Application No. 10-2014-0152856 filed on Nov. 5, 2014, in the Korean Intellectual Property Office, the entire disclosure of which is incorporated herein by reference.

### BACKGROUND

1. Field of the Invention

The present invention relates generally to an electronic device and a method of controlling the same.

2. Description of the Related Art

As various kinds of electronic devices, such as smartphones, tablet personal computers (PCs), notebook computers, wearable devices, etc., are practically used, various kinds of content available to the electronic devices are being provided. For example, the electronic devices may reproduce various kinds of content, such as photographs, videos, e-books, e-mails, etc. As specifications of the electronic devices are enhanced and storage space increases, the number, size, length, etc. of content available to users are increasing. For example, a user may view hundreds to thousands of photographs, tens of videos, a number of e-books, etc. by using a smartphone. However, as the number, length, etc. of content increases, it is difficult for a user to search for desired content or a desired portion of content.

### SUMMARY

The present invention has been made to address at least the problems and disadvantages described above, and to provide at least the advantages described below.

Accordingly, an aspect of the present invention is to enable a user to easily change displayed content objects when a plurality of content objects are being displayed.

Accordingly, another aspect of the present invention is to decrease the number of manipulations by a user when the user changes content objects to be displayed.

In accordance with an aspect of the present invention, an electronic device is provided. The electronic device includes a photographing unit configured to photograph a hand including fingers, a display unit configured to display a plurality of content objects, and a control unit configured to recognize a finger gesture of the photographed hand and a distance from the electronic device to the fingers and control the display unit to change and display a range of a displayed content object according to the recognized finger gesture and the distance.

In accordance with another aspect of the present invention, an electronic device control method is provided. The method includes displaying a plurality of content objects, photographing a hand including fingers recognizing a finger gesture of the photographed hand and a distance from the electronic device to the fingers, and changing a range of a displayed content object according to the recognized finger gesture and the distance.

### BRIEF DESCRIPTION OF THE DRAWINGS

The above and other aspects, features, and advantages of the present invention will become apparent from the following detailed description taken in conjunction with the accompanying drawings in which:

FIG. 1 illustrates a method of changing a range of a content object displayed by an electronic device, according to an embodiment of the present invention;

FIG. 2 is a diagram of a structure of an electronic device, according to an embodiment of the present invention;

FIG. 3 is a diagram of an electronic device having a photographing unit disposed on a front surface, according to an embodiment of the present invention;

FIG. 4 is a diagram of an electronic device having a photographing unit disposed on a rear surface, according to an embodiment of the present invention;

FIG. 5 is a diagram of an electronic device having a photographing unit disposed on a surface, according to an embodiment of the present invention;

FIG. 6 is a diagram illustrating a motion of inputting a user input requesting a photographing unit to start photographing, according to an embodiment of the present invention;

FIG. 7 is a diagram illustrating finger gestures, according to an embodiment of the present invention;

FIG. 8 is a flowchart of an electronic device control method, according to an embodiment of the present invention;

FIGS. 9 to 11 are diagrams illustrating a method of changing a range of displayed thumbnail image content objects, according to an embodiment of the present invention;

FIGS. 12 to 14 are diagrams illustrating a method of changing a range of displayed e-mail content objects, according to an embodiment of the present invention;

FIGS. 15 to 17 are diagrams illustrating a method of changing a range of displayed e-book content objects, according to an embodiment of the present invention;

FIGS. 18 to 20 are diagrams illustrating a method of changing a range of displayed video content objects, according to an embodiment of the present invention;

FIG. 21 is a diagram illustrating a method of terminating changing a range of a displayed content object, according to an embodiment of the present invention;

FIG. 22 is a diagram illustrating a method of continuously changing a range of a displayed content object, according to an embodiment of the present invention;

FIG. 23 is a diagram illustrating a method of defining a finger gesture, according to an embodiment of the present invention;

FIG. 24 is a diagram illustrating a method of defining a finger gesture, according to an embodiment of the present invention;

FIG. 25 is a diagram illustrating a method of changing a displayed content object depending on a distance to a finger, according to an embodiment of the present invention;

FIG. 26 is a diagram for illustrating a method of changing a displayed content object depending on a distance to a finger, according to an embodiment of the present invention;

FIG. 27 is a diagram illustrating a method of displaying content objects when changing ranges of displayed content objects, according to an embodiment of the present invention;

FIG. 28 is a diagram of a screen of an electronic device displayed when changing a range of displayed content objects, according to an embodiment of the present invention;

FIG. 29 is a diagram of a finger gesture guide screen of an electronic device, according to an embodiment of the present invention; and

FIG. 30 is a block diagram of a configuration of an electronic device, according to an embodiment of the present invention.

### DETAILED DESCRIPTION OF EMBODIMENTS OF THE PRESENT INVENTION

Reference will now be made in detail to embodiments of the present invention, examples of which are illustrated in the accompanying drawings, wherein like reference numerals refer to like elements throughout. In this regard, the embodiments of the present invention may have different forms and should not be construed as being limited to the descriptions set forth herein. Accordingly, the embodiments of the present invention are merely described below, by referring to the figures, to explain the various aspects of the present invention. Therefore, the embodiments of the present invention described herein are provided so that this disclosure will be thorough and complete, and will fully convey the scope of the invention to those of ordinary skill in the art.

As used herein, the term “and/or” includes any and all combinations of one or more of the associated listed items. Expressions such as “at least one of,” when preceding a list of elements, modify the entire list of elements and do not modify the individual elements of the list.

Terms used herein have been selected as general terms which are widely used at present, in consideration of the functions of the present invention. Unless otherwise defined, all terns used herein, including technical and scientific terms, have the same meaning as commonly understood by those of skill in the art to which the present invention pertains. Such terms as those defined in a generally used dictionary are to be interpreted to have the same meanings as the contextual meanings in the relevant field of art, and are not to be interpreted to have ideal or excessively formal meanings, unless clearly defined herein.

When it is described that an element comprises (or includes or has) some other elements, it should be understood that the element may comprise (or include or have) only those other elements, or may comprise (or include or have) additional elements as well as those other elements if there is no specific limitation.

The term “module”, as used herein, means, but is not limited to, a software or hardware component, such as a field programmable gate array (FPGA) or an application specific integrated circuit (ASIC), which performs certain tasks. A module may advantageously be configured to reside in the addressable storage medium and configured to execute on one or more processors. Thus, a module may include, by way of example, components, such as software components, object-oriented software components, class components, task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Various embodiments of the present invention will now be described in detail with reference to the accompanying drawings. In addition, descriptions of well-known functions and constructions are omitted for clarity.

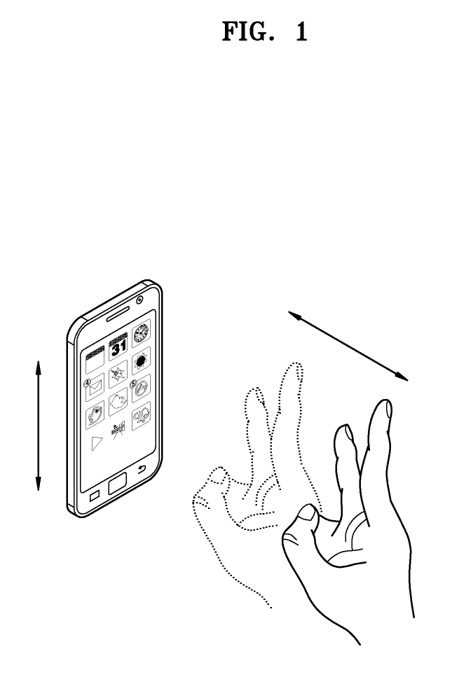

FIG. 1 illustrates a method of changing a range of a content object displayed by an electronic device, according to an embodiment of the present invention.

Referring to FIG. 1, an electronic device 100 is provided. A user may change a range of a content object displayed by the electronic device 100 by adjusting a distance from the electronic device 100 to a hand, which makes a finger gesture toward a photographing unit included in the electronic device 100.

The electronic device 100 may be implemented as, for example, various kinds of devices, such as a smartphone, a tablet personal computer (PC), a television (TV), a wearable device, a notebook computer, an e-book terminal, a portable phone, etc.

The content object is an object representing certain content. The content object may be an object where corresponding content is reproduced when the object is selected. For example, the content object may include a thumbnail image corresponding to a still image or a moving image, an application execution icon, an object representing an e-mail, a music file icon, a contact number, etc. Alternatively, the content object may be a unit of reproduction with respect to certain content. For example, the content object may include a video frame, a table of contents or pages of e-books, a date or a schedule of a calendar function, a notice of a social network service (SNS), etc.

Changing a range of displayed content object refers to sequentially changing a range of a content object displayed on a screen. For example, a content object displayed on a screen may be changed to be in the form of a scroll or the like.

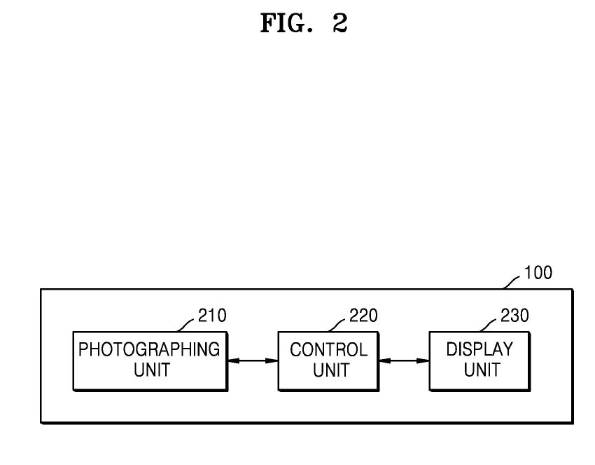

FIG. 2 is a diagram of a structure of an electronic device, according to an embodiment of the present invention.

Referring to FIG. 2, the electronic device 100 includes a photographing unit 210, a control unit 220, and a display unit 230.

The photographing unit 210 photographs a subject. The photographing unit 210 may include a lens, an aperture, a shutter, and an imaging device. Additionally, the electronic device may include a plurality of photographing units.

The lens may include a plurality of lens groups and a plurality of lenses. A position of the lens may be adjusted by a lens driver of the photographing unit 210. The lens driver adjusts a position of the lens to adjust a focus distance or correct shaking of a hand.

An opening/closing degree of the aperture is adjusted by an aperture driver of the photographing unit 210 to control the amount of light incident on the imaging device. The aperture driver adjusts the aperture to adjust a depth of a captured image.

An optical signal passing through the lens and the aperture is transferred to a light receiving surface of the imaging device to generate an image of a subject. The imaging device may be a charge coupled device (CCD) image sensor or a complementary metal oxide semiconductor (CIS) image sensor that converts an optical signal into an electrical signal. A sensitivity and the like of the imaging device is adjusted by an image device controller of the photographing unit 210. The imaging device controller controls the image device according to a control signal. The control signal may be automatically generated according to an image signal which is input in real time or may be manually input through manipulation by a user.

An exposure time of the imaging device is adjusted by using the shutter. The shutter may be categorized into a mechanical shutter, which moves a shade to adjust the amount of incident light, and an electronic shutter that supplies an electrical signal to the imaging device to control exposure.

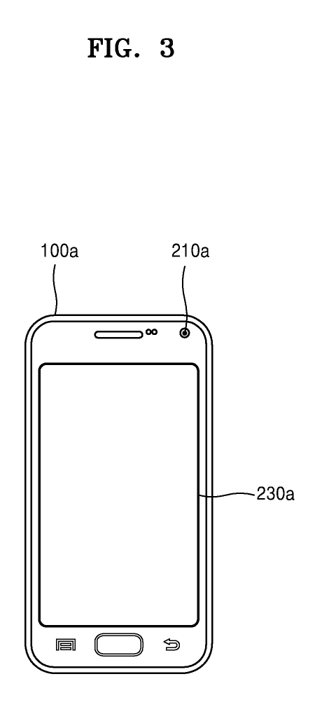

FIG. 3 is a diagram of an electronic device having a photographing unit disposed on a front surface, according to an embodiment of the present invention.

Referring to FIG. 3, an electronic device 100a having a photographing unit 210a disposed on a front surface is provided. That is, the photographing unit 210a is disposed on the same surface as a display unit 230a. In this case, when a user moves one or more fingers in front of the display unit 230a while performing a finger gesture, the finger gesture is photographed by the photographing unit 210a and a distance from the one or more fingers to the electronic device 100 is measured.

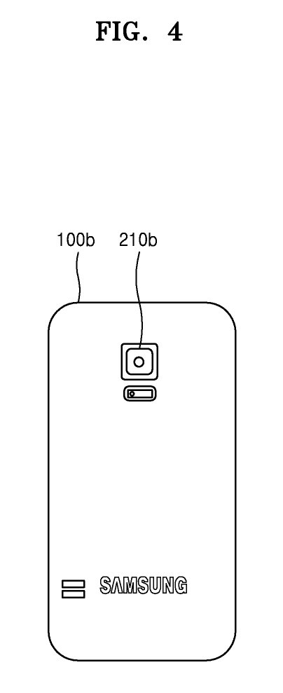

FIG. 4 is a diagram of an electronic device having a photographing unit disposed on a rear surface, according to an embodiment of the present invention.

Referring to FIG. 4, an electronic device 100b having a photographing unit 210b disposed on a rear surface is provided. That is, the photographing unit 210b may be additionally, or alternatively, disposed on a surface which differs from the surface on which the display unit 230 is disposed. In this case, a user may move his or her fingers behind the display unit 230 while performing a finger gesture, thereby preventing the fingers from covering the display unit 230 which would obstruct a field of view. In this case the figure gesture is photographed by the photographing unit 210b and a distance from the fingers to the electronic device 100b is measured.

Accordingly, the photographing units 210a and 210b may be disposed on a surface which is the same as or different from the display unit 230. In this case, the user may select which of the photographing unit 210a or 210b is to be used for photographing a hand including the fingers.

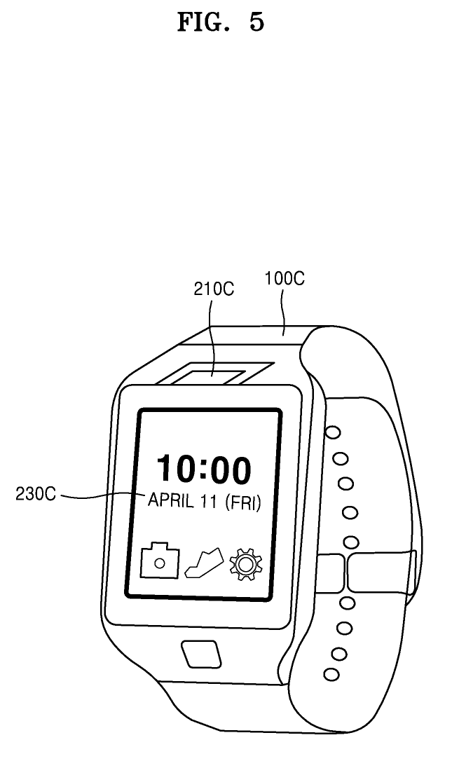

FIG. 5 is a diagram of an electronic device having a photographing unit disposed on a surface, according to an embodiment of the present invention.

Referring to FIG. 5, an electronic device 100c implemented as a smart watch is provided. A photographing unit 210c is disposed near a watch face or on a watch strap of the electronic device 100c. In a wearable device, such as the electronic device 200, where a size of a display unit 230c is small and it is difficult to manipulate, in comparison with larger electronic devices, a user interface convenient for use in the wearable device may be provided by changing a range of a content object which is displayed by photographing a hand including fingers using the photographing unit 210c.

An operation of the photographing unit 210 will be described with reference to FIG. 2.

The photographing unit 210 may photograph a user's hand including the fingers. The photographing unit 210 may photograph various parts of the user's hand. The photographing unit 210 may perform photographing according to a current mode or a user input.

When an input for requesting photographing of a hand is received from a user while a certain function (for example, a photograph album, video reproduction, etc.) of displaying a plurality of content objects is being executed, the photographing unit 210 continuously photographs a hand including one or more fingers. The photographing unit 210 may continuously photograph the fingers at a certain frame rate. For example, the photographing unit 210 may photograph the fingers at a frame rate of 30 frames/sec, 60 frames/sec, or the like.

Alternatively, when an input for requesting photographing of a hand is received from a user while a certain function of displaying a plurality of content objects is being executed, the photographing unit 210 may photograph a hand including one or more fingers at least once, and when a finger gesture of the hand is photographed, the control unit 220 activates a sensor (for example, an infrared (IR) sensor, a proximity sensor, a depth camera, etc.) for measuring a distance from the photographing unit 210 to the one or more fingers. In this case, the control unit 220 measures the distance to one or more recognized fingers by using the sensor.

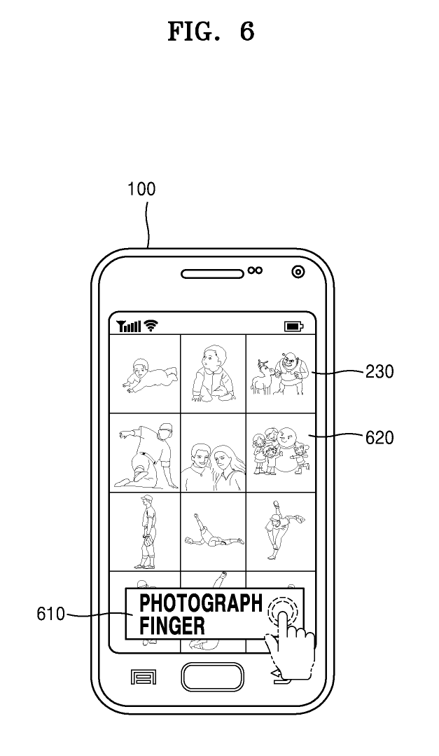

FIG. 6 is a diagram illustrating a motion of inputting a user input requesting a photographing unit to start photographing, according to an embodiment of the present invention.

Referring to FIG. 6, an electronic device 100 is provided. The display unit 230 displays a menu 610 for inputting a command to photograph a finger, and a user selects the menu 610 by applying a touch input to the display unit 230 to start to photograph the finger. The menu 610 may be provided on a screen that displays a plurality of content objects 620.

The command to photograph a finger may be received by the photographing unit 210 by using a key input. In this case, when a key input is received in a certain function of displaying a plurality of content objects, the photographing unit 210 begins to photograph the finger. For example, when a certain key of the electronic device 100 is pressed, photographing of the finger begins, and when another key input is applied to the electronic device 100, photographing of the finger ends. As another example, photographing of a finger may be performed in a state of pressing a certain key of the electronic device 100, and when the certain key is released, photographing of the finger ends.

A command to end photographing of a finger may additionally be received by the photographing unit 210 according to a user input. The user input may be, for example, a touch input, a key input, etc. which is applied through a user interface of the electronic device 100. The user input may additionally be a certain finger gesture detected from a captured image. For example, when a finger gesture corresponding to a fist shape is detected from a captured image, the photographing unit 210 may end photographing.

The photographing unit 210 may further include a depth camera for measuring a distance to a subject. In this case, the photographing unit 210 includes the depth camera and an imaging camera.

The control unit 220 recognizes, from an image captured by the photographing unit 210, a finger gesture and a distance from the electronic device 100 to a finger and controls the display unit 230 to change and display a range of a displayed content object, based on the finger gesture and the distance.

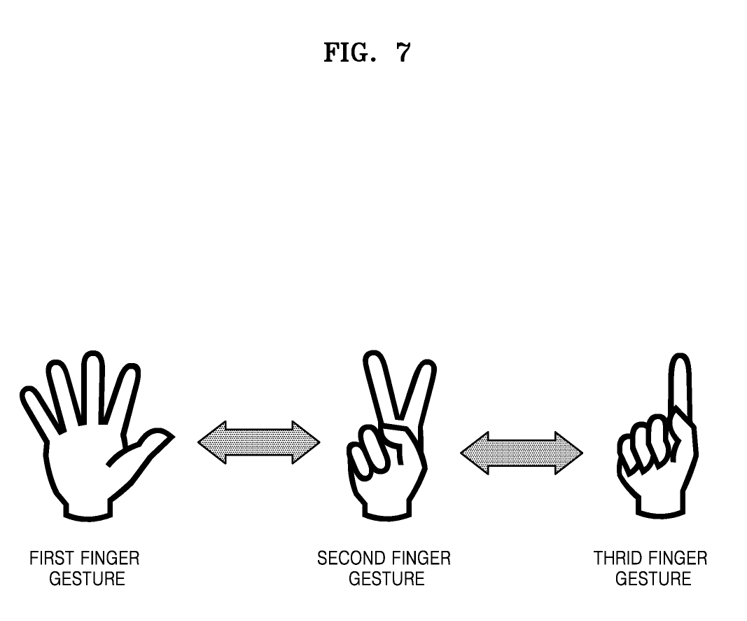

FIG. 7 is a diagram illustrating a finger gestures, according to an embodiment of the present invention.

Referring to FIG. 7, various finger gestures are shown. The control unit 220 determines whether a corresponding photographed part is a part of a human body, based on color information of a subject and further determines a finger gesture, based on a posture of a finger. A finger gesture is a gesture performed by using a combination of a folded state and an opened state of one or more fingers. A plurality of finger gestures may be previously defined in the electronic device 100. For example, a first finger gesture where five fingers are all opened, a second finger gesture where a forefinger and a middle finger are opened and a thumb, a ring finger, and a little finger are folded, and a third finger gesture where the forefinger is opened and the other fingers are all folded may be previously defined in the electronic device 100.

Additionally, information related to each of the finger gestures is stored in the electronic device 100. For example, when a user defines a finger gesture the user may input information related to the finger gesture to the electronic device 100. For example, the user may make a finger gesture which is to be newly defined, photograph the finger gesture with the electronic device 100, and input information related to the finger gesture to the electronic device 100.

A distance from the electronic device 100 to a finger may be measured by various kinds of sensors. The electronic device 100 may include an IR sensor, a proximity sensor, etc. In this case, the control unit 220 measures the distance from the electronic device 100 to the finger by using a sensing value of a sensor.

Alternatively or additionally, the electronic device 100 may include a depth camera. In this case, the control unit 220 measures the distance from the electronic device 100 to the finger by using the depth camera.

Alternatively or additionally, the control unit 220 may measure the distance from the electronic device 100 to the finger by using auto-focusing (AF) information of the photographing unit 210. In this case, the control unit 220 measures the distance from the electronic device 100 to the finger by using information including a focus evaluation value, a focus distance, etc.

Alternatively or additionally, the control unit 220 may measure the distance from the electronic device 100 to the finger, based on a change in a size of a finger gesture in a captured image.

The display unit 230 displays a plurality of content objects. The display unit 230 may be implemented as, for example, a touch screen. Also, the display unit 230 may be implemented as, for example, a liquid crystal display (LCD), an organic light-emitting display, an electrophoretic display, or the like.

The electronic device 100 changes the displayed content objects based on a figure gesture.

The electronic device 100 switches a unit for changing the displayed content objects based on a change in a distance of a finger gesture. For example, while a plurality of content objects, such as thumbnail images corresponding to image data, are being displayed, when a distance to a finger is changed by using the first finger gesture, the electronic device 100 may change the displayed plurality of thumbnail images by a first unit, such as a year unit. When the distance to the finger is changed by using the second finger gesture, the electronic device 100 may change the displayed plurality of thumbnail images by a second unit, such as a month unit. When the distance to the finger is changed by using the third finger gesture, the electronic device 100 may change the displayed plurality of thumbnail images by a third unit, such as a day unit.

A ‘unit for changing a content object’ refers to a measurement unit by which a displayed content object is incremented or decremented whenever the electronic device 100 detects that a distance to a finger has changed by a predefined. For example, a content object which is displayed by a unit for changing a content object may be switched whenever a distance to a finger is changed by 3 cm.

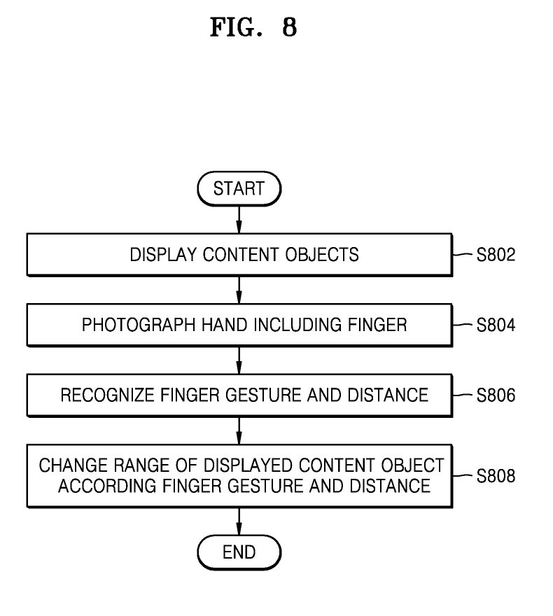

FIG. 8 is a flowchart of an electronic device control method, according to an embodiment of the present invention.

Referring to FIG. 8, the electronic device control method may be performed by various types of electronic devices.

In step S802, the electronic device 100 displays a plurality of content objects. The electronic device 100 displays the plurality of content objects while executing a function or a mode of displaying a plurality of content objects. For example, the electronic device 100 displays a plurality of thumbnail images in the middle of performing a photograph album function.

In step S804, the electronic device 100 photographs a user's hand including fingers. For example, a finger may be automatically photographed depending on a state of the electronic device 100, or may be photographed according to a user input. The electronic device 100 may continuously photograph a finger at a certain frame rate. Alternatively, the electronic device 100 photographs a finger a predetermined number of times according to a user input.

In step S806, the electronic device 100 recognizes a finger gesture from a captured image and measures a distance from the electronic device 100 to the finger. The distance to the finger, as described above, may be measured with an IR sensor, a proximity sensor, a depth camera, or using AF information of the captured image.

In step S808, the electronic device 100 changes a range of each of the displayed content objects, based on the recognized finger gesture and distance.

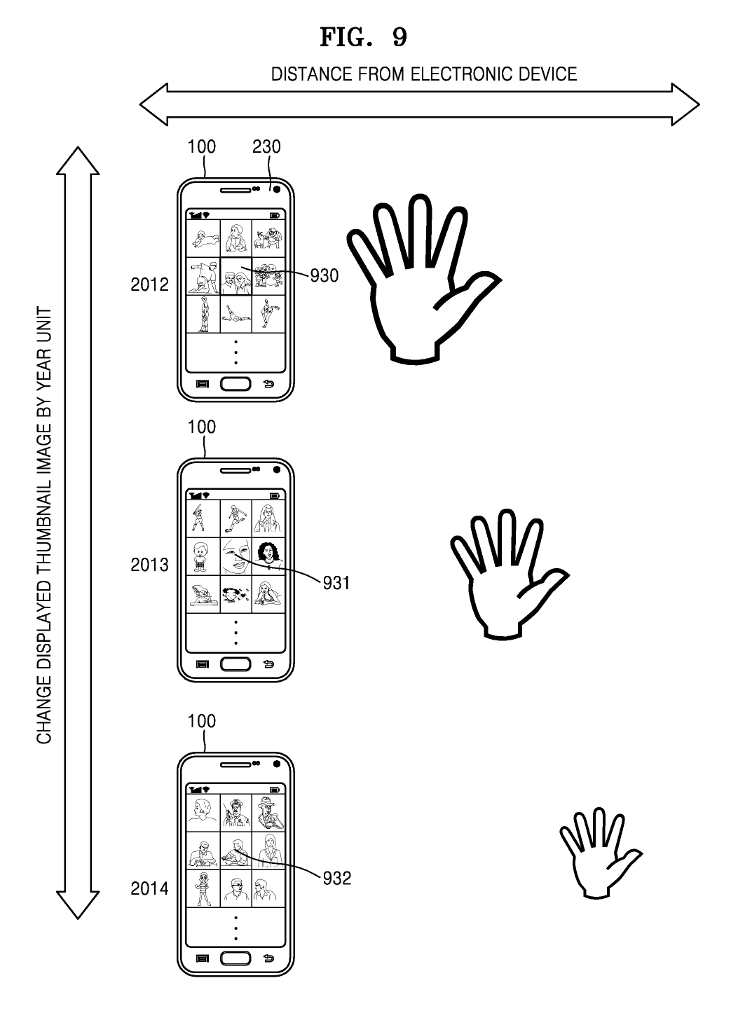

FIGS. 9 to 11 are diagrams for describing illustrating a method of changing a range of displayed thumbnail image content objects, according to an embodiment of the present invention.

Referring to FIGS. 9 to 11, while a plurality of content objects, such as thumbnail images, are being displayed, when a distance to a finger is changed by using the first finger gesture, the electronic device 100 changes the displayed plurality of thumbnail images by a first unit, such as a year unit. When the distance to the finger is changed by using the second finger gesture, the electronic device 100 changes the displayed plurality of thumbnail images by a second unit, such as a month unit. When the distance to the finger is changed by using the third finger gesture, the electronic device 100 changes the displayed plurality of thumbnail images by a third unit, such as a day unit.

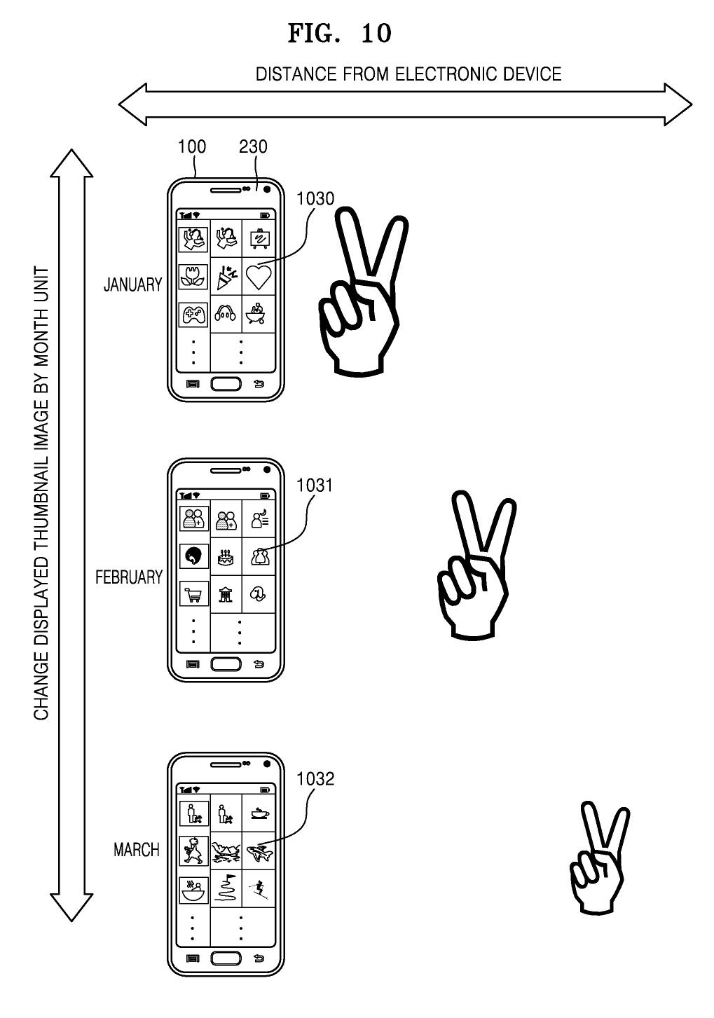

Referring to FIG. 9, while thumbnail images 930 are being displayed by the display unit 230, when a user changes a distance from the electronic device 100 to a finger by using the first finger gesture, the displayed thumbnail images 930 are changed by a year unit. For example, while the display unit 230 is displaying thumbnail images 930 of a plurality of images captured around July 2012, if the user changes a distance from the electronic device 100 to a finger by using the first finger gesture, the electronic device 100 changes the displayed thumbnail images 930 in one-year increments whenever the distance from the electronic device 100 to the finger is changed by a certain unit length (for example, 3 cm). For example, as the finger moves farther away from the electronic device 100 in a state of making the first finger gesture, the display unit 230 sequentially displays thumbnail images 931 of a plurality of images captured around July 2013, and then thumbnail images 932 of a plurality of images captured around July 2014, etc. Referring to FIG. 10, while thumbnail images 1030 are being displayed by the display unit 230, when a user changes a distance from the electronic device 100 to a finger by using the second finger gesture, the displayed thumbnail images 1030 are changed by a month unit. For example, while the display unit 230 is displaying thumbnail images 1030 of a plurality of images captured around January 2014, if the user changes a distance from the electronic device 100 to a finger by using the second finger gesture, the electronic device 100 changes the displayed thumbnail images 1030 in one-month increments whenever the distance from the electronic device 100 to the finger is changed by a certain unit length (for example, 3 cm). For example, as the finger moves farther away from the electronic device 100 in a state of making the second finger gesture, the display unit 230 sequentially displays thumbnail images 1031 of a plurality of images captured around February 2014 and thumbnail images 1032 of a plurality of images captured around March 2014, etc.

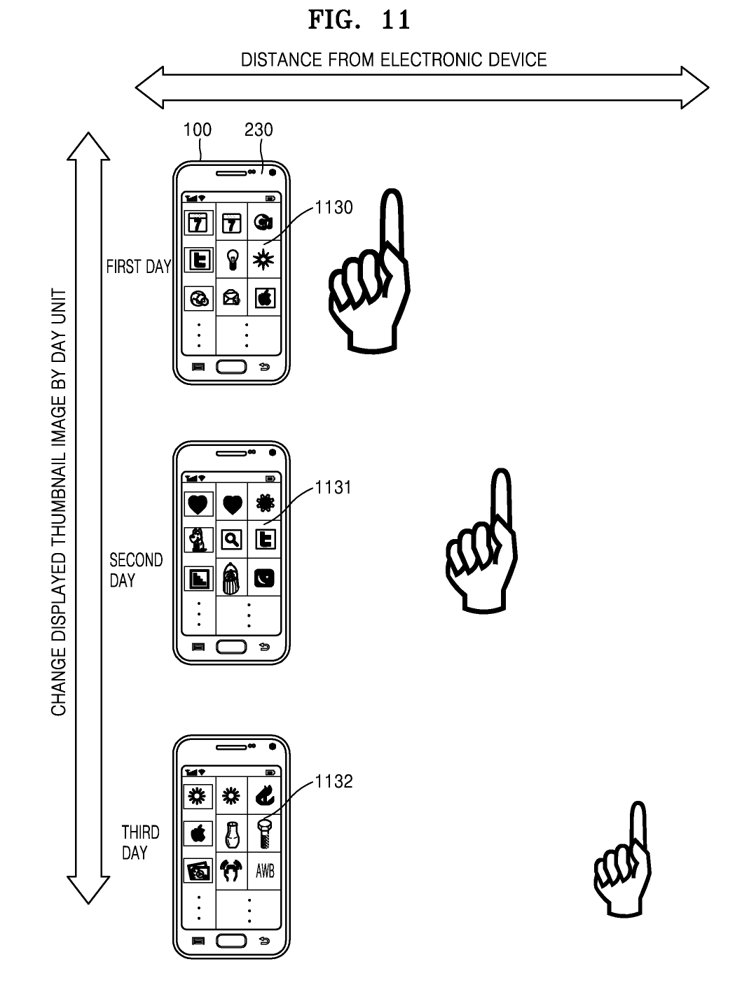

Referring to FIG. 11, while thumbnail images 1130 are being displayed by the display unit 230, when a user changes a distance from the electronic device 100 to a finger by using the third finger gesture, the displayed thumbnail images 1130 are changed by a day unit. For example, while the display unit 230 is displaying thumbnail images 1130 of a plurality of images captured on Jan. 1, 2014, if the user changes a distance from the electronic device 100 to a finger by using the third finger gesture, the electronic device 100 changes the displayed thumbnail images in one day increments whenever the distance from the electronic device 100 to the finger is changed by a certain unit length (for example, 3 cm). For example, as the finger moves farther away from the electronic device 100 in a state of making the third finger gesture, the display unit 230 sequentially displays thumbnail images 1131 of a plurality of images captured on Jan. 2, 2014 and thumbnail images 1132 of a plurality of images captured on Jan. 3, 2014, etc.

At least one or a combination of the number of content objects displayed on one screen and a layout representing a content object is changed according to a recognized finger gesture. For example, when the first finger gesture is recognized, a plurality of thumbnail images may be displayed as a layout illustrated in FIG. 9. When the second finger gesture is recognized, a plurality of thumbnail images may be displayed as a layout illustrated in FIG. 10. When the third finger gesture is recognized, a plurality of thumbnail images may be displayed as a layout illustrated in FIG. 11.

A unit length is a reference distance for changing a plurality of displayed content objects. The unit length is changed according to a recognized finger gesture. For example, the unit length may be 5 cm in the first finger gesture, may be 3 cm in the second finger gesture, and may be 1 cm in the third finger gesture. Also, as an interval at which a range of changing a displayed content object corresponding to a finger gesture is changed increases, the unit length may increase, and as the interval at which a range of changing a displayed content object corresponding to a finger gesture is changed is reduced, the unit length may be reduced.

The photographing unit 210 may continuously capture a hand image including a finger at a certain frame rate, and when a captured image is generated, the control unit 220 determines whether a finger gesture maintains a recognized finger gesture. The control unit 220 changes a range of a displayed content object when a distance to a finger is changed while the finger gesture is maintaining the recognized finger gesture. When the recognized finger gesture is changed, the control unit 220 recognizes a changed finger gesture and changes a range of the displayed content object according to the distance to the finger being changed by a unit for changing a content object corresponding to the changed finger gesture. For example, when the recognized finger gesture is not a predefined finger gesture, the control unit 220 does not change the displayed content object despite the distance to the finger being changed.

The control unit 220 increases or decreases an order of a displayed content object according to a direction in which a distance to a finger is changed. For example, when a plurality of thumbnail images are arranged with respect to photographed dates, a user may make a certain finger gesture and may change a distance to a finger. In this case, when the distance to the finger is reduced, thumbnail images of an image captured prior to a plurality of currently displayed thumbnail images are displayed, and when the distance to the finger increases, thumbnail images of an image captured after the plurality of currently displayed thumbnail images are displayed

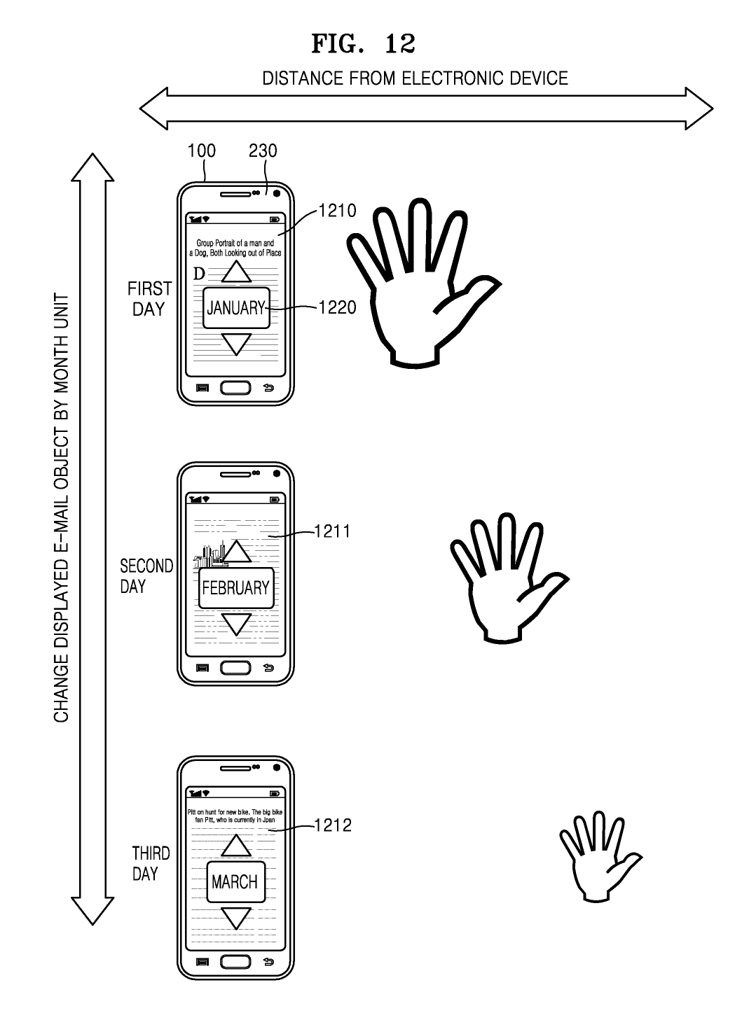

FIGS. 12 to 14 are diagrams illustrating a method of changing a range of displayed e-mail content objects, according to an embodiment of the present invention.

Referring to FIGS. 12 to 14, while the electronic device 100 is displaying a plurality of e-mail objects 1210, when a user changes a distance to a finger by using the first finger gesture, the electronic device 100 changes the displayed e-mail objects 1210 by a first unit, such as a month unit. When the user changes the distance to the finger by using the second finger gesture, the electronic device 100 changes the displayed e-mail objects 1210 by a second unit, such as a week unit. When the user changes the distance to the finger by using the third finger gesture, the electronic device 100 changes the displayed e-mail objects 1210 by a third unit, such as a day unit.

Here, each of the e-mail objects 1210 is an object where a text of an e-mail is displayed when a corresponding object is selected. Each of the e-mail objects 1210 may be displayed in a form of displaying a title of an e-mail, a form of displaying an icon corresponding to the e-mail, etc.

Each of the e-mail objects 1210 may include attributes such as a title, a received date, a sender, a mail text, a size, etc. When the e-mail objects 1210 are displayed by the display unit 230, the e-mail objects 1210 may be arranged with respect to one of the attributes. For example, the e-mail objects 1210 being arranged and displayed with respect to a mail-received date may be a default. As another example, the e-mail objects 1210 may be arranged based on the attributes, such as the title, the sender, the size, and/or the like, according to a selection by the user.

The control unit 220 determines a unit of change for changing a range of each of the displayed e-mail objects 1210 according to a distance to a finger and a reference distance where the e-mail objects 1210 are currently arranged, based on a recognized finger gesture. For example, when the e-mail objects 1210 are arranged with respect to the received date, the control unit 220 determines the unit of change as a year, a month, a day, etc. When the e-mail objects 1210 are arranged with respect to the sender, the control unit 220 determines the unit of change as a consonant unit, a person unit, an individual mail unit, etc. The control unit 220 changes the displayed e-mail objects 1210 according to the distance to the finger and the reference distance where the e-mail objects 1210 are currently arranged, based on the recognized finger gesture.

Referring to FIG. 12, while a plurality of e-mail objects 1210 are being displayed by the display unit 230, when a user changes a distance from the electronic device 100 to a finger by using the first finger gesture, the displayed e-mail objects 1210 are changed by a month unit. For example, while the display unit 230 is displaying a plurality of e-mail objects 1210 corresponding to e-mails received around January 2014, if the user changes a distance from the electronic device 100 to a finger by using the first finger gesture, the electronic device 100 changes the displayed e-mail objects 1210 in one month increments whenever the distance from the electronic device 100 to the finger is changed by a certain unit length (for example, 3 cm). For example, as the finger moves farther away from the electronic device 100 in a state of making the first finger gesture, the display unit 230 sequentially displays a plurality of e-mail objects 1211 corresponding to e-mails received around February 2014 and a plurality of e-mail objects 1212 corresponding to e-mails received around March 2014, etc.

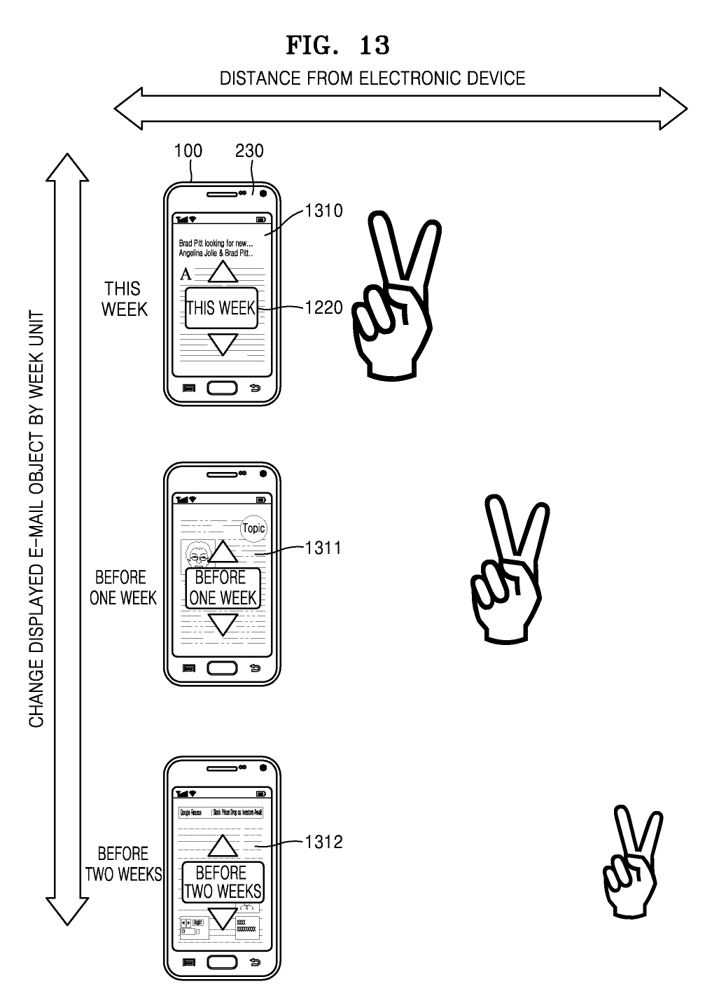

The control unit 220 displays a cover 1220, representing a range of a currently displayed content object, in the display unit 230 for guiding a range of a displayed content object being changed. Also, the cover 1220 representing the range of the currently displayed content object may include information about a change unit of a range of a displayed content object corresponding to a recognized finger gesture. In this case, when the recognized finger gesture is changed, the control unit 220 changes the cover 1220 according to the recognized finger gesture. Also, as a distance to a finger is changed, the control unit 220 changes the cover 1220 to correspond to the range of the displayed content object. Referring to FIG. 13, while a plurality of e-mail objects 1310 are being displayed by the display unit 230, when a user changes a distance from the electronic device 100 to a finger by using the second finger gesture, the displayed e-mail objects 1310 are changed by a week unit. For example, while the display unit 230 is displaying a plurality of e-mail objects 1310 corresponding to e-mails received this week, if the user changes a distance from the electronic device 100 to a finger by using the second finger gesture, the electronic device 100 changes the displayed e-mail objects 1310 in one week increments whenever the distance from the electronic device 100 to the finger is changed by a certain unit length (for example, 3 cm). For example, as the finger moves farther away from the electronic device 100 in a state of making the second finger gesture, the display unit 230 sequentially displays a plurality of e-mail objects 1311 corresponding to e-mails received one week before, and a plurality of e-mail objects 1312 corresponding to e-mails received two weeks before.

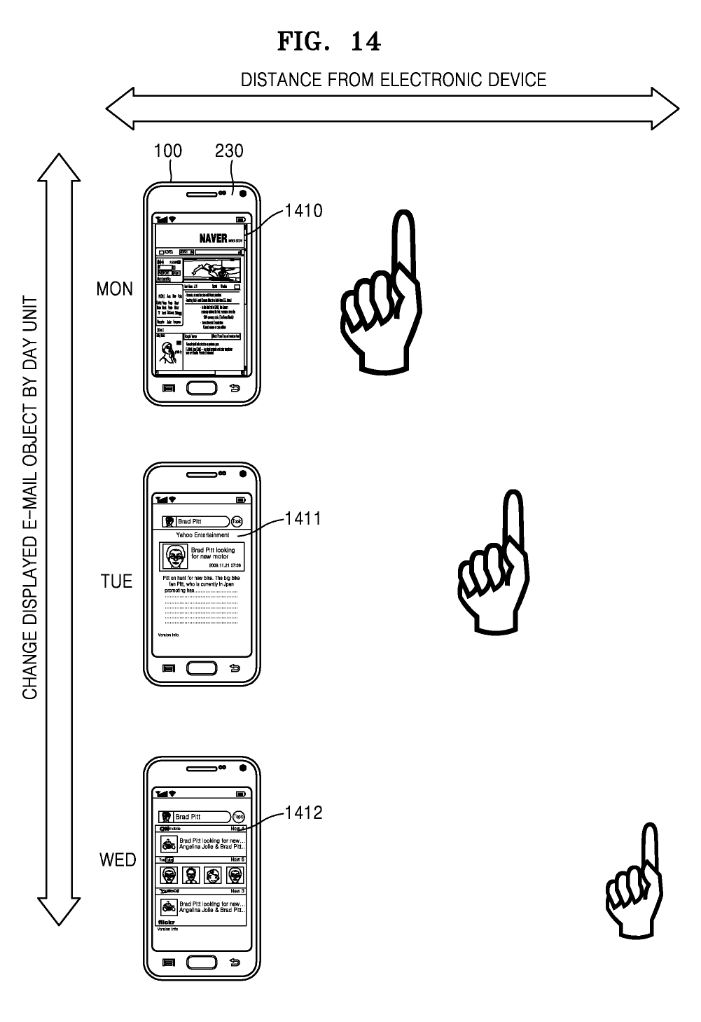

Referring to FIG. 14, while a plurality of e-mail objects 1210 are being displayed by the display unit 230, when a user changes a distance from the electronic device 100 to a finger by using the third finger gesture, the displayed e-mail objects 1410 are changed by a day unit. For example, while the display unit 230 is displaying a plurality of e-mail objects 1410 corresponding to e-mails received on Monday, if the user changes a distance from the electronic device 100 to a finger by using the third finger gesture, the electronic device 100 changes the displayed e-mail objects 1410 in one day increments whenever the distance from the electronic device 100 to the finger is changed by a certain unit length (for example, 3 cm). For example, as the finger moves farther away from the electronic device 100 in a state of making the third finger gesture, the display unit 230 sequentially displays a plurality of e-mail objects 1411 corresponding to e-mails received on Tuesday and a plurality of e-mail objects 1412 corresponding to e-mails received on Wednesday, etc.

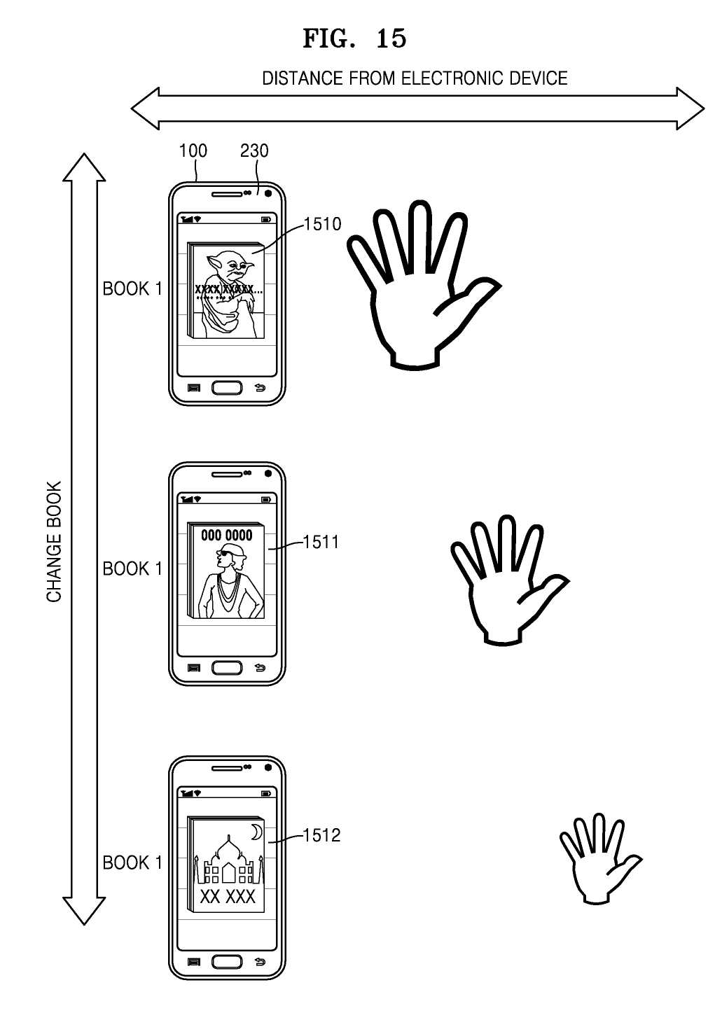

FIGS. 15 to 17 are diagrams illustrating a method of changing a range of displayed e-book content objects, according to an embodiment of the present invention.

Referring to FIGS. 9 to 11, while the electronic device 100 is displaying an e-book content object, when a user changes a distance to a finger by using the first finger gesture, the electronic device 100 changes the displayed e-book content object by a first unit, such as a book unit. When the user changes the distance to the finger by using the second finger gesture, the electronic device 100 changes the displayed e-book content object by a second unit, such as content-table unit. When the user changes the distance to the finger by using the third finger gesture, the electronic device 100 changes the displayed e-book content object by a third unit, such as a page unit.

The e-book content object includes a book cover object 1510, a content-table object 1610, and an e-book page object 1710.

Referring to FIG. 15, the book cover object 1510 is a bundle of e-book pages defined as a volume unit. The book cover object 1510 may be displayed in the form of book covers. As another example, the book cover object 1510 may be displayed in the form of book titles. The book cover object 1510 may include, for example, attributes such as a book title, an author, a publication date of a first edition, a publisher, popularity, a purchased date, etc. An arrangement reference for arranging the book cover object 1510 may be changed according to a setting by the electronic device 100 or a selection by a user. An arrangement reference of the book cover object 1510 may be selected from among, for example, a book title, an author, a publication date of a first edition, popularity, a purchased date, etc.

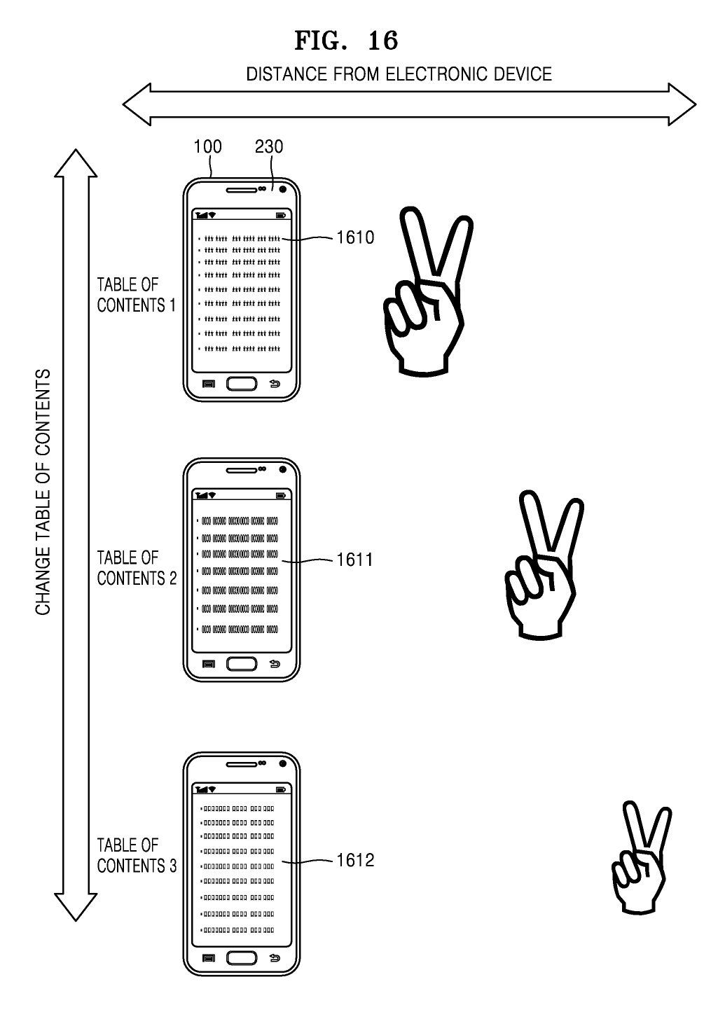

Referring to FIG. 16, the content-table object 1610 corresponds to a table of contents of books included in the book cover object 1510 of one book, and when a corresponding object is selected, an e-book page corresponding to a selected table of contents is displayed. The content-table object 1610 may be provided, for example, in a form where a content-table title is displayed as a text, a form where a table of contents is displayed as an icon, and/or the like.

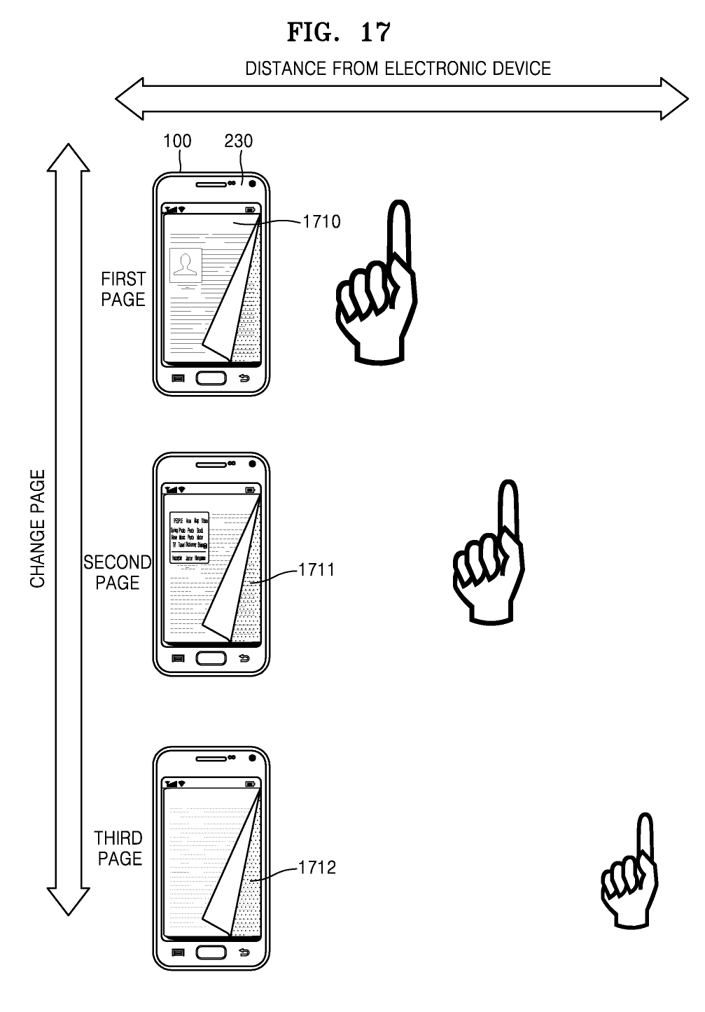

Referring to FIG. 17, the e-book page object 1710 is a screen corresponding to each of the pages of a book. The e-book page object 1710 may include a text, a picture, and/or the like of a book body. The e-book page object 1710 may be defined as a size corresponding to a size of the display unit 230. Also, a display form of the e-book page object 1710 may be changed according to a user input. The e-book page object 1710 may be changed in various forms such as a form where a page is turned, a form where a screen is changed from a first page to a second page, and/or the like.

Referring back to FIG. 15, while an e-book content object is being displayed by the display unit 230, when a user changes a distance from the electronic device 100 to a finger by using the first finger gesture, the displayed e-book content object is changed by a volume unit. Here, the e-book content object being displayed may include the book cover object 1510, the content-table object 1610, and the e-book page object 1710. For example, while the display unit 230 is displaying arbitrary e-book content, if the user changes a distance from the electronic device 100 to a finger by using the first finger gesture, the electronic device 100 changes the book cover object 1510 displayed in volume increments whenever the distance from the electronic device 100 to the finger is changed by a certain unit length (for example, 3 cm). For example, as the finger moves farther away from the electronic device 100 in a state of making the first finger gesture, the display unit 230 sequentially displays a book cover object 1510 corresponding to a book 1, a book cover object 1511 corresponding to a book 2, a book cover object 1512 corresponding to a book 3, etc.

The control unit 220 changes the displayed book cover objects 1510 according to the distance to the finger and a distance reference where the book cover objects 1510 are currently arranged, based on a recognized finger gesture. For example, when the book cover objects 1510 are arranged with respect to purchased dates, the control unit 220 changes the book cover objects 1510 displayed in the order of purchased dates according to the distance to the finger, and when the book cover objects 1510 are arranged with respect to book titles, the control unit 220 changes the book cover objects 1510 displayed in the order of book titles according to the distance to the finger.

Referring back to FIG. 16, while an e-book content object is being displayed by the display unit 230, when a user changes a distance from the electronic device 100 to a finger by using the second finger gesture, the displayed e-book content object is changed by a content-table unit. In this case, an e-book content object may be changed by a content-table unit in a currently selected or currently displayed book. For example, in a state where a book cover object 1510 corresponding to a book 1 is selected or the display unit 230 displays an e-book page 1710 or a content-table object 1610 corresponding to the book 1, if the user changes a distance from the electronic device 100 to a finger by using the second finger gesture, the electronic device 100 changes the e-book content object displayed in content-table increments whenever the distance from the electronic device 100 to the finger is changed by a certain unit length (for example, 3 cm). For example, as the finger moves farther away from the electronic device 100 in a state of making the second finger gesture, the display unit 230 sequentially displays a content-table object 1610 corresponding to a table of contents 1, a content-table object 1611 corresponding to a table of contents 2, a content-table object 1612 corresponding to a table of contents 3, etc.

Referring to FIG. 17, while an e-book content object is being displayed by the display unit 230, when a user changes a distance from the electronic device 100 to a finger by using the third finger gesture, the displayed e-book content object is changed by a page unit. For example, while the display unit 230 is displaying a first page of an e-book, if the user changes a distance from the electronic device 100 to a finger by using the third finger gesture, the electronic device 100 changes an e-book page object 1710 displayed by in one page increments whenever the distance from the electronic device 100 to the finger is changed by a certain unit length (for example, 3 cm). For example, as the finger moves farther away from the electronic device 100 in a state of making the third finger gesture, the display unit 230 sequentially displays an e-book second page 1711, and an e-book third page 1712, etc.

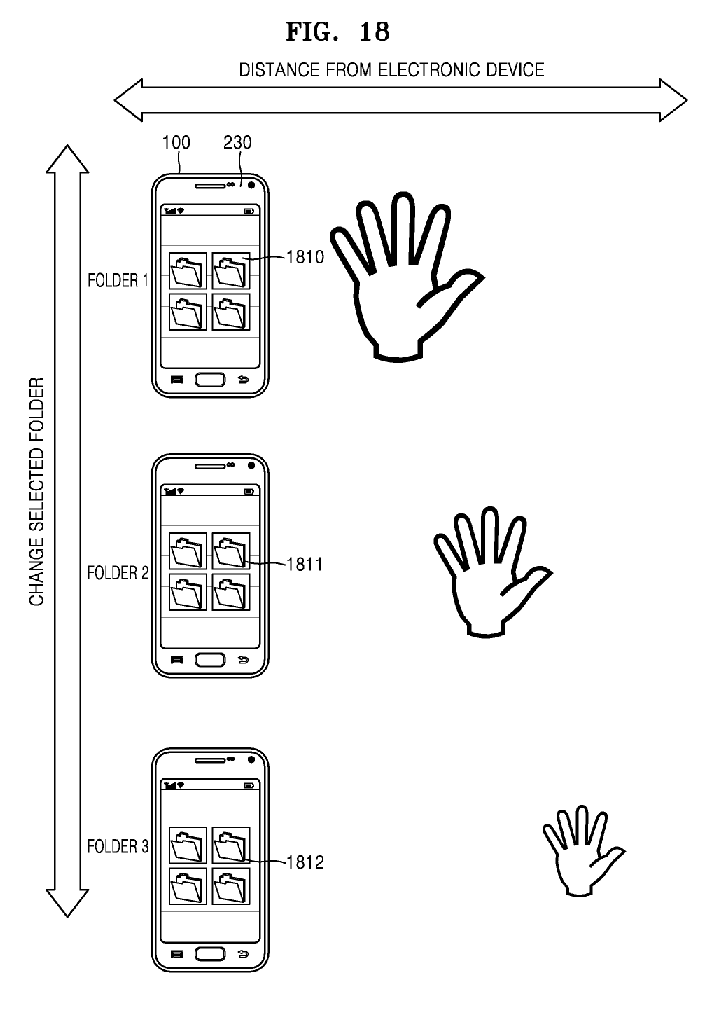

FIGS. 18 to 20 are diagrams illustrating a method of changing a range of displayed video content objects, according to an embodiment of the present invention.

Referring to FIGS. 18 to 20, while the electronic device 100 is displaying a video content object, when a user changes a distance to a finger by using the first finger gesture, the electronic device 100 changes the displayed video content object by a first unit, such as a folder unit. When the user changes the distance to the finger by using the second finger gesture, the electronic device 100 changes the displayed video content object by a second unit, such as a file unit. When the user changes the distance to the finger by using the third finger gesture, the electronic device 100 changes a reproduction time of the displayed video content object by a third unit, such as a time unit.

The video content object may include a video file folder object 1810, a video file object 1910, and a video frame object 2010.

Referring to FIG. 18, the video file folder object 1810 is a bundle of video files including at least one video file.

The video file folder object 1810 is a storage space for storing a video file. The video file folder object 1810 including a plurality of video files may be selected based on a user input.

The video file folder object 1810 stores video files classified based on attributes of the video files. For example, when a video file is a part of a series, the video file may have attributes related to the series, such as genre, season, etc. The video files may be classified by series and stored in the video file folder object 1810. In this case, the video file folder object 1810 may have attributes such as genre, season, etc. and may include video files having corresponding attributes.

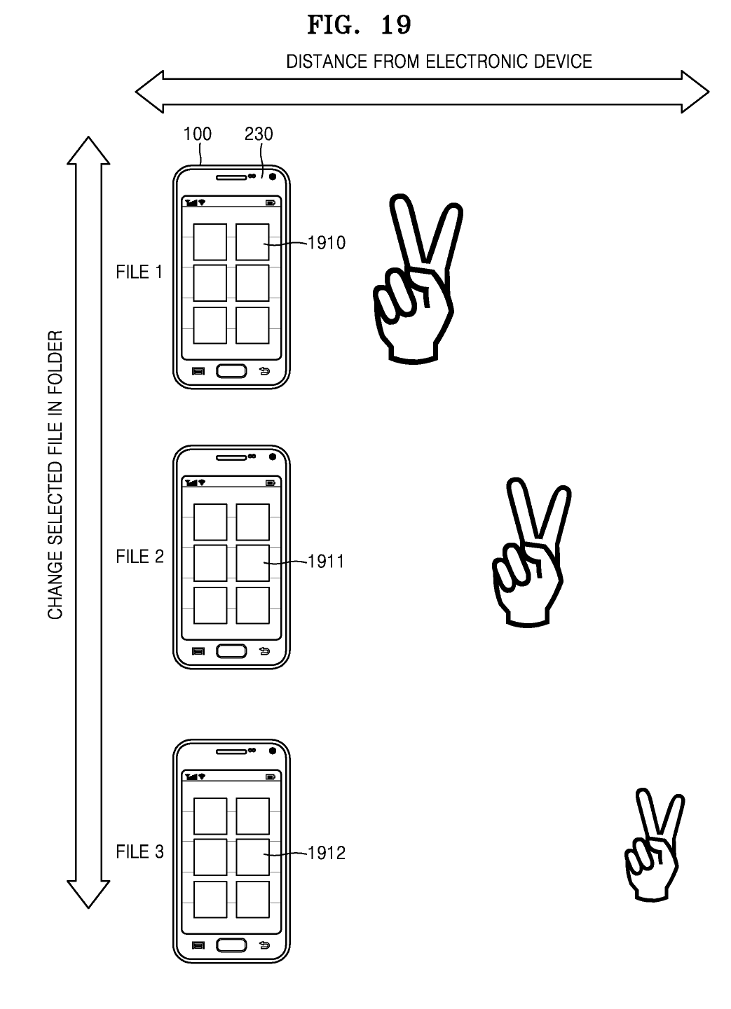

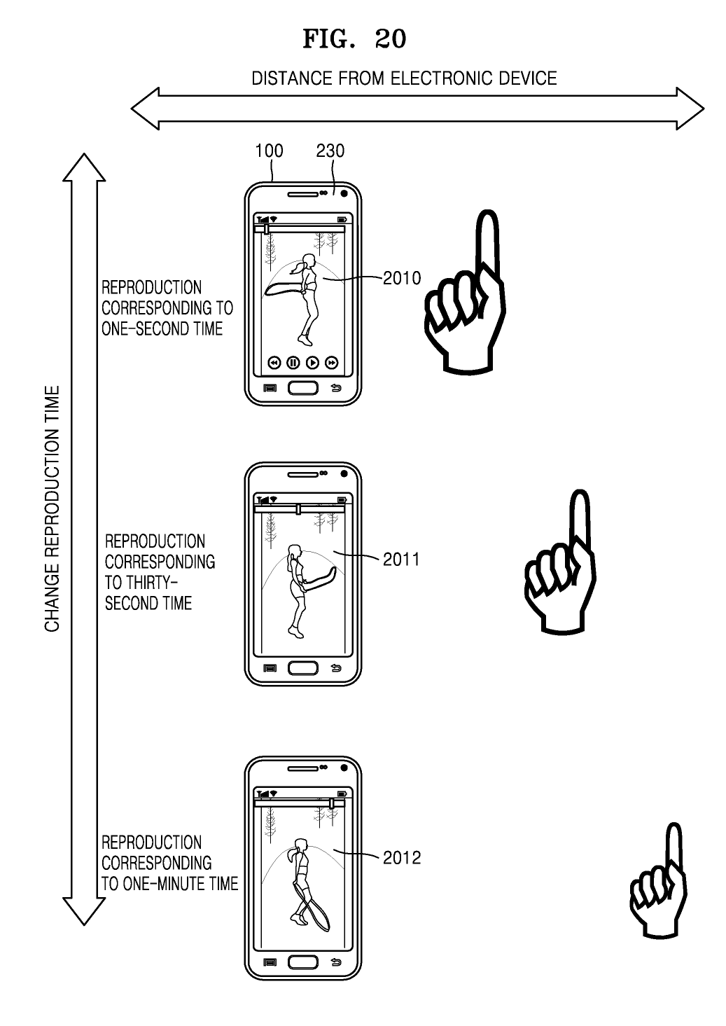

Referring to FIG. 19, the video file object 1910 may be displayed on the display unit 230 in the form of a thumbnail image. The video file object 1910 stores video frames obtained through encoding. The video file object 1910 may be encoded according to, for example, various standards such as moving picture experts group (MPEG), audio visual interleave (AVI), window media video (WMV), quick time movie (MOV), MatrosKa multimedia container for video (MKV), and/or the like. Referring to FIG. 20, the video frame object 2010 is a frame included in a video file object 1910. The video frame object 2010 is reproduced in a form of continuously reproducing a plurality of video frames.

Referring back to FIG. 18, while a video content object is being displayed by the display unit 230, when a user changes a distance from the electronic device 100 to a finger by using the first finger gesture, the displayed video content object is changed by a video folder unit. Here, the video content object being displayed may the video folder object 1810, the video file object 1910, and a video frame object 2010. For example, while the display unit 230 is displaying a video content object, if the user changes a distance from the electronic device 100 to a finger by using the first finger gesture, the electronic device 100 changes the video folder object 1810 displayed by a folder unit whenever the distance from the electronic device 100 to the finger is changed by a certain unit length (for example, 3 cm). For example, as the finger moves farther away from the electronic device 100 in a state of making the first finger gesture, the display unit 230 sequentially displays the video folder object 1810 corresponding to a folder 1, a video folder object 1811 corresponding to a folder 2, and a video folder object 1812 corresponding to a folder 3, etc. The control unit 220 changes the displayed video folder objects 1810 according to the distance to the finger and a reference distance where the video folder objects 1810 are currently arranged, based on a recognized finger gesture. For example, when the video folder objects 1810 are arranged with respect to modification dates, the control unit 220 changes the video folder objects 1810 displayed in the order of the modification dates according to the distance to the finger, and when the video folder objects 1810 are arranged with respect to titles, the control unit 220 changes the video folder objects 1810 displayed in the order of titles according to the distance to the finger.

Referring back to FIG. 19, while a video content object is being displayed by the display unit 230, when a user changes a distance from the electronic device 100 to a finger by using the second finger gesture, the displayed video content object is changed by a file unit. In this case, a video content object is changed by a file unit in a currently selected folder. For example, in a state where a video folder object 1810 corresponding to a folder 1 is selected or the display unit 230 is displaying a plurality of video file objects 1910 corresponding to the video folder object 1810 corresponding to the folder 1, if the user changes a distance from the electronic device 100 to a finger by using the second finger gesture, the electronic device 100 changes the video folder objects 1910 displayed or selected by a file unit whenever the distance from the electronic device 100 to the finger is changed by a certain unit length (for example, 3 cm). For example, as the finger moves farther away from the electronic device 100 in a state of making the second finger gesture, the display unit 230 sequentially displays a video file object 1910 corresponding to a file 1, a video file object 1911 corresponding to a file 2, and a video file object 1912 corresponding to a file 2, etc.

Referring back to FIG. 20, while a video content object is being displayed by the display unit 230, when a user changes a distance from the electronic device 100 to a finger by using the third finger gesture, the displayed video content object is changed by a certain reproduction time unit. For example, while a video file object 1910 is being reproduced and displayed in the display unit 230, if the user changes a distance from the electronic device 100 to a finger by using the third finger gesture, the electronic device 100 changes a video frame object 2010 displayed in certain reproduction time increments (for example, 30 secs) whenever the distance from the electronic device 100 to the finger is changed by a certain unit length (for example, 3 cm). For example, as the finger moves farther away from the electronic device 100 in a state of making the third finger gesture, the display unit 230 sequentially displays a video frame object 2011 corresponding to a reproduction time advanced 30 secs, and displays a video frame object 2012 corresponding to a reproduction time advanced 1 min, etc.

The content object may be an object of a calendar function, and an object of a calendar displayed by a year unit, a month unit, and a day unit may be changed according to a finger gesture and a distance to a finger.

The content object may be an object of SNS, and a displayed SNS notice may be changed by a year unit, a month unit, and a day unit according to the finger gesture and the distance to the finger.

The content object may be an object of a map, and an area of a displayed map may be changed by a mile unit, a yard unit, a feet unit, etc. units according to the finger gesture and the distance to the finger.

The content object may be a music content object, and a displayed or selected music content object may be changed by album, musician, track number, etc. units according to the finger gesture and the distance to the finger.

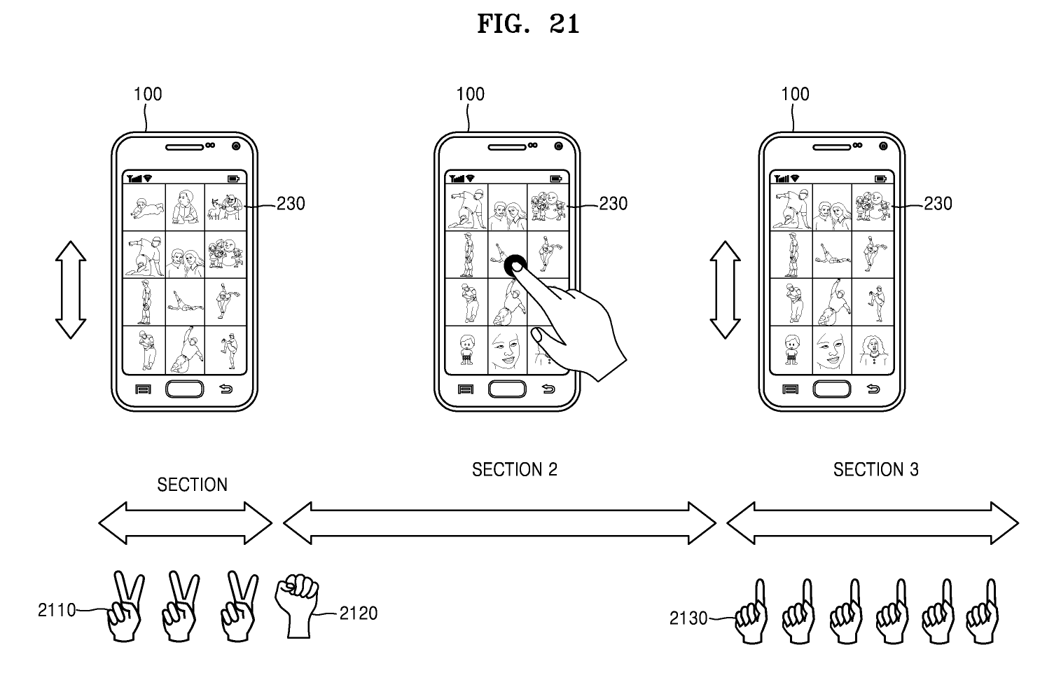

FIG. 21 is a diagram illustrating a method of terminating changing a range of a displayed content object, according to an embodiment of the present invention.

Referring to FIG. 21, a finger gesture for terminating changing a range of a displayed content object may be previously defined, and the finger gesture and information related to the finger gesture are stored in the electronic device 100. For example, a fourth finger gesture 2120, where five fingers are all folded, may be defined as the finger gesture for terminating changing a range of a displayed content object. The fourth finger gesture 2120 may be defined in various other manners.

When a user changes a distance to a finger in a state of maintaining a second finger gesture 2110, as illustrated in FIG. 21, and then makes the fourth finger gesture 2120, thereby terminating changing a range of a displayed content object.

Changing of a range of a displayed content object may be terminated, and then, when the electronic device 100 recognizes a third finger gesture 2130 in a captured image, the range of the displayed content object may be changed according to a distance to a finger as shown in section 3.

When changing a range of a displayed content object is terminated, the electronic device 100 stops an operation of photographing, by the photographing unit 210, a hand including a finger. Subsequently, when a user input for requesting photographing of the hand is received, the electronic device 100 may start to photograph the hand including the finger, recognize a finger gesture in the captured image shown in section 3, and change the range of the displayed content object according to a distance to the finger.

The user may make the fourth finger gesture to terminate changing a range of a displayed content object, and by applying a touch input, a key input, etc. to the electronic device 100, the user changes the range of the displayed or selected content object.

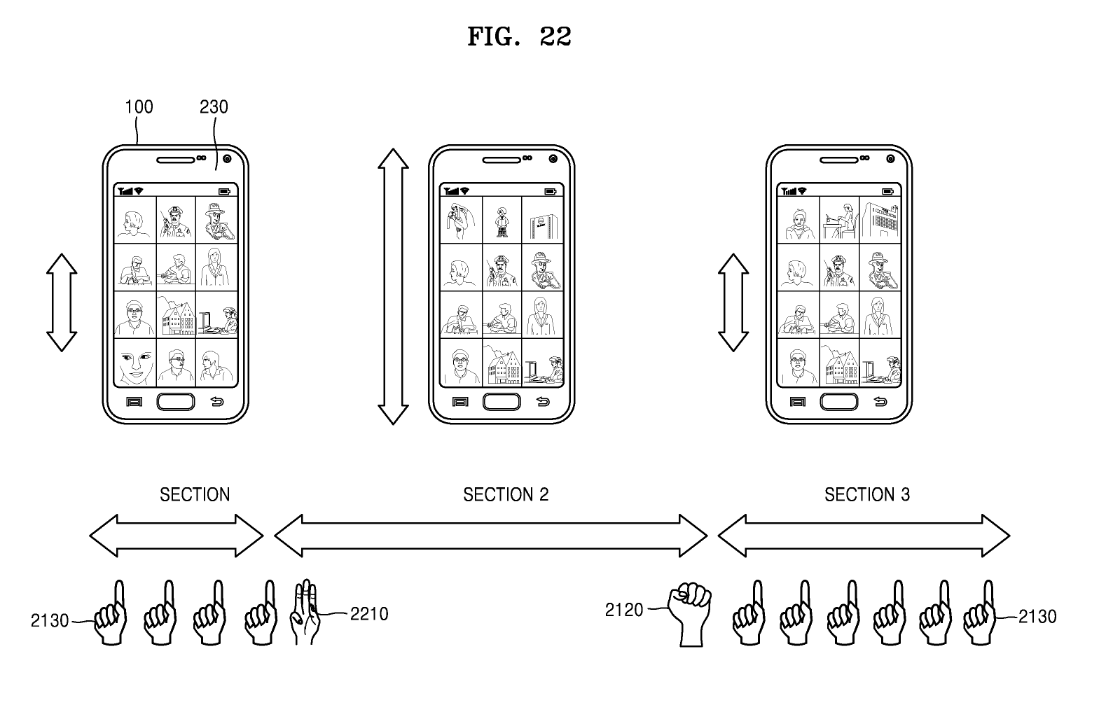

FIG. 22 is a diagram illustrating a method of continuously changing a range of a displayed content object, according to an embodiment of the present invention.

Referring to FIG. 22, a fifth finger gesture 2210 for continuously changing a range of a displayed content object may be defined. For example, the fifth finger gesture 2210 may be defined as a gesture where a forefinger, a middle finger, and a ring finger are opened. In addition, the fifth finger gesture 2210 may be defined in various other manners.

When the fifth finger gesture 2210 is recognized, although a distance to a finger is not changed, the electronic device 100 continuously changes a range of a displayed content object until a signal for issuing a request to terminate changing the range of the displayed content object is received. For example, if the fifth finger gesture 2210 is recognized, although a distance to a finger is not changed, the electronic device 100 may continuously scroll a plurality of displayed thumbnail images.

Alternatively, when the fifth finger gesture 2210 is recognized, although the fifth finger gesture 2210 is not continuously recognized, the electronic device 100 continuously changes a range of a displayed content object until a signal for terminating changing the range of the displayed content object is received. The signal for terminating changing the range of the displayed content object may be input in a form of a touch input, a key input, an image input including a finger gesture, or the like. For example, as illustrated in FIG. 22, when a fifth finger gesture has been recognized and a range of a displayed content object is being continuously changed, if the predefined fourth finger gesture 2120 is recognized, the electronic device 100 terminates changing the range of the displayed content object.

The electronic device 100 continuously changes a range of a displayed content object while the fifth finger gesture 2210 is being recognized, and when the fifth finger gesture 2210 is not recognized, the electronic device 100 terminates changing the range of the displayed content object.

A unit of change and a scroll direction where a range of a content object, which is displayed when the fifth finger gesture 2210 is recognized is changed, may be determined based on a unit of change and a scroll direction where a range of a recently displayed content object is changed. For example, as illustrated in FIG. 22, a user may increase a distance to a finger in a state of making a third finger gesture 2130, as shown in section 1, and thus, the electronic device 100 changes a thumbnail image, displayed by a day unit, to a thumbnail image which is recently captured by scrolling in a direction toward the recently captured image. Subsequently, when the user makes the fifth finger gesture 2210, as shown in section 2, the electronic device 100 changes the thumbnail image which is displayed by a date unit, to a thumbnail image which is previously captured by scrolling in the direction toward the previously captured image. For example, the user may decrease the distance to the finger in a state of making the third finger gesture 2130, as shown in section 1, and thus, the electronic device 100 changes a thumbnail image, displayed by a day unit, to a thumbnail image of a previously captured image by scrolling in a direction toward the previously captured image. Subsequently, when the user makes the fifth finger gesture 2210, as shown in section 2, the electronic device 100 changes, by a day unit, the thumbnail image which is displayed in the direction toward the previously captured image.

If changing a range of a displayed content object is terminated, the electronic device 100 recognizes a predefined finger gesture, as shown in section 3 to change the range of the displayed content object according to a finger gesture and a distance to a finger.

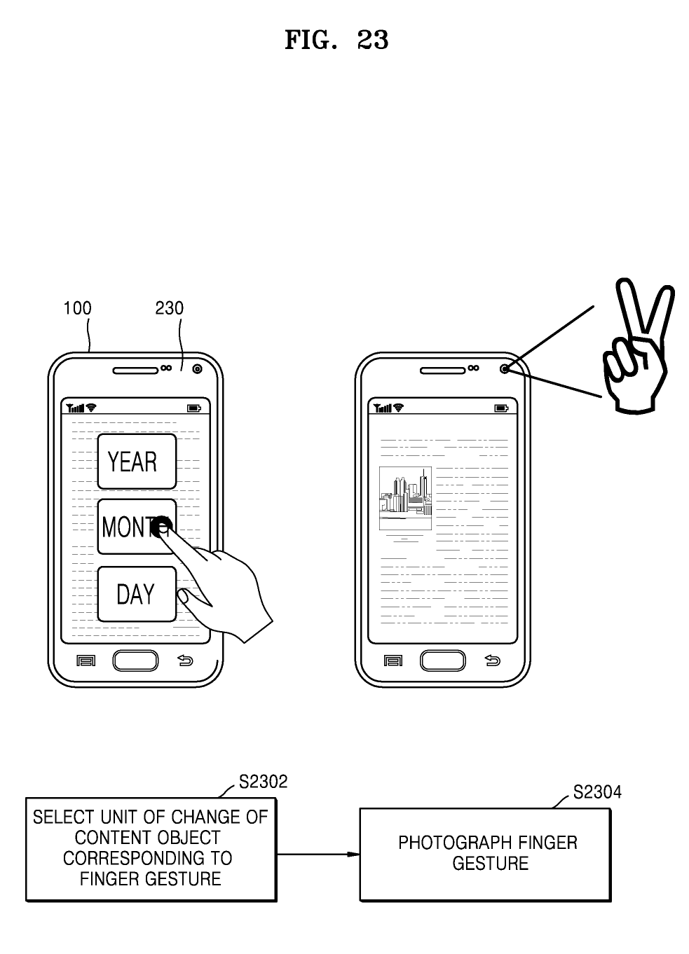

FIG. 23 is a diagram for illustrating a method of defining a finger gesture, according to an exemplary embodiment.

Referring to FIG. 23, the electronic device 100 provides a function which enables a user to directly define a finger gesture for changing a range of a displayed content object. In the finger gesture definition function, a finger gesture and a unit for changing a displayed content object corresponding to the finger gesture may be defined.

For example, as illustrated in FIG. 23, while the finger gesture definition function is being performed, the electronic device 100 provides a user interface S2302 for allowing a user to select a unit for changing a displayed content object corresponding to the finger gesture and a user interface 2304 for photographing a finger gesture.

A finger gesture may be previously photographed, and then, a unit for changing a displayed content object corresponding to the finger gesture may be selected.

In the finger gesture definition function, the user selects the kind of content for using the finger gesture or a function of the electronic device 100. For example, the user may select whether to apply a finger gesture to a photograph album function or an e-book function.

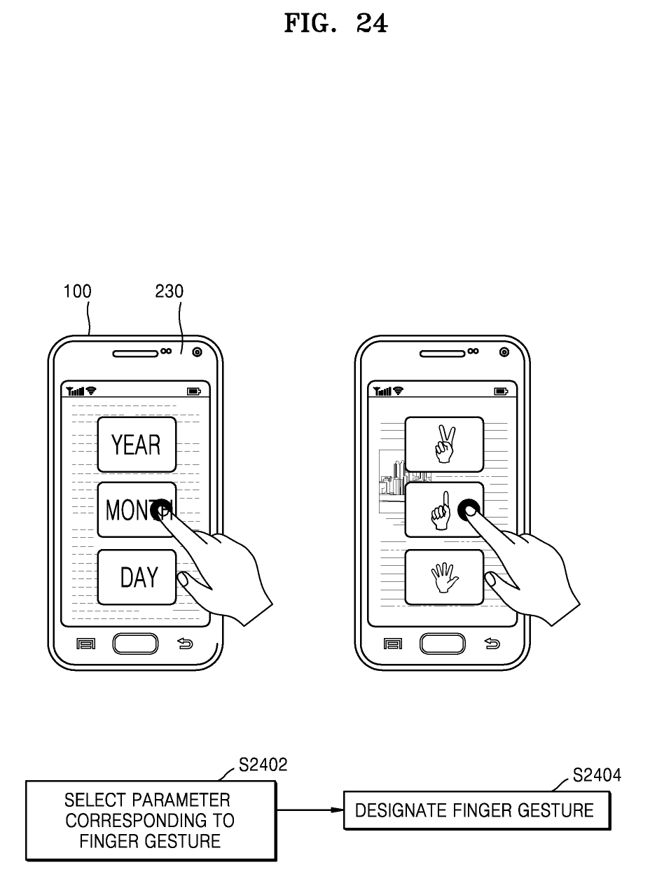

FIG. 24 is a diagram illustrating a method of defining a finger gesture, according to an embodiment of the present invention.

Referring to FIG. 24, in the finger gesture definition function, the electronic device 100 provides user interfaces for allowing a user to select a finger gesture from among a plurality of finger gestures which are predefined in the electronic device 100 and to select various parameters associated with the selected finger gesture. For example, while the finger gesture definition function is being performed, the electronic device 100 provides a user interface S2402 for allowing the user to select a unit for changing a displayed content object corresponding to the finger gesture and a user interface S2404 for allowing the user to select a finger gesture from among a plurality of available finger gestures stored in the electronic device 100 and displayed on the display unit 230.

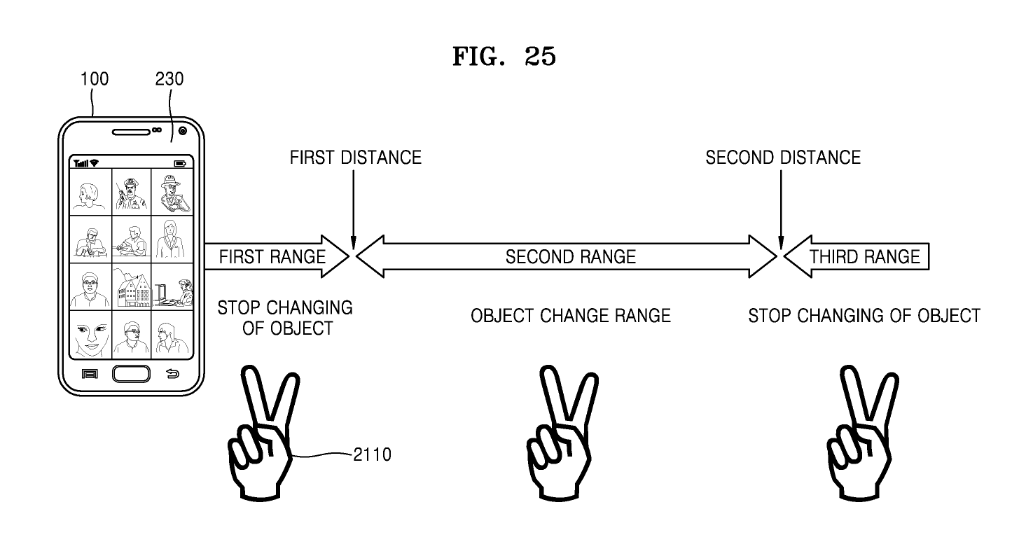

FIG. 25 is a diagram illustrating a method of changing a displayed content object depending on a distance to a finger, according to an embodiment of the present invention.

Referring to FIG. 25, when a distance from the electronic device 100 to a finger is within a certain range, the electronic device 100 changes a displayed content object according to a distance to the finger, but when the distance from the electronic device 100 to the finger is outside the certain range, the electronic device 100 does not change the displayed content object according to the distance to the finger. For example, when a finger gesture 2110 is recognized in a first range, i.e. within a first distance from the electronic device 100, the electronic device 100 may not change a range of a displayed content object despite a distance to a finger being changed. When a finger gesture 2110 is recognized in a second range, i.e., from the first distance to a second distance, the electronic device 100 changes the range of the displayed content object according to the distance to the finger. When the finger gesture 2110 is recognized in a third range, i.e., from the second distance and greater, the electronic device 100 does not change the range of the displayed content object despite the distance to the finger being changed.

The first range and the second range may be defined in various manners, such as using an absolute distance from the electronic device 100 to a finger, a size of a recognized finger, etc.

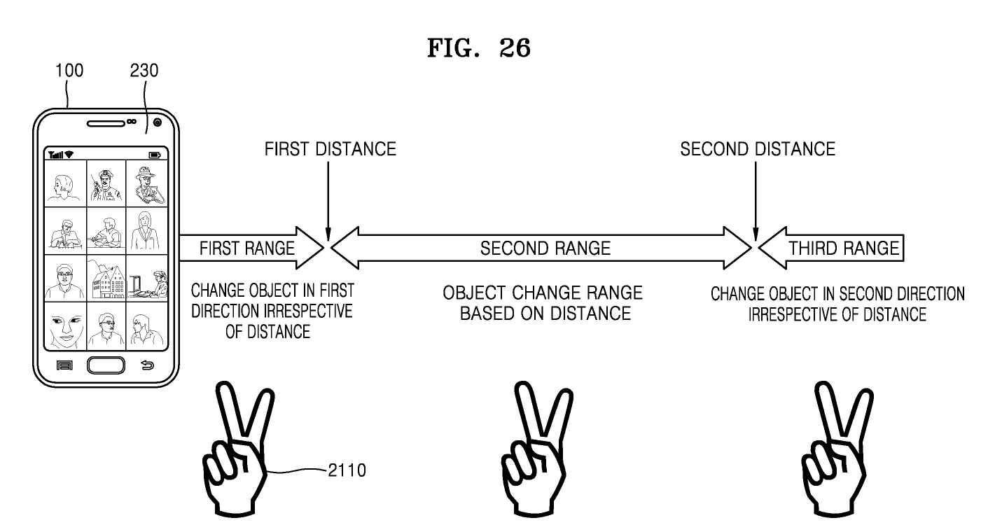

FIG. 26 is a diagram for illustrating a method of changing a displayed content object depending on a distance to a finger, according to an embodiment of the present invention.

Referring to FIG. 26, when a distance from the electronic device 100 to a finger is within a certain range, the electronic device 100 changes a displayed content object according to a distance to the finger, and when the distance to the finger is outside the certain range, the electronic device 100 changes a displayed content object irrespective of a change in the distance to the finger. For example, when a finger gesture 2110 is recognized in a first range, i.e., within a distance from the electronic device 100, the electronic device 100 changes a range of a displayed content object in a first direction irrespective of a change in the distance to the finger. When a finger gesture 2110 is recognized in a second range, i.e., from the first distance to a second distance, the electronic device 100 changes the range of the displayed content object according to the distance to the finger. When the finger gesture 2110 is recognized in a third range, i.e., from the second distance and greater, the electronic device 100 changes the range of the displayed content object in a second direction irrespective of the change in the distance to the finger.

When in the first range, the first direction is a direction of the previously captured image,

When in the second range, the first direction and the second direction are related to a direction in which the distance to the finger is changed. For example, when the distance to the finger is reduced in the second range, the electronic device 100 may scroll the displayed thumbnail images in a direction of a previously captured image, and when the distance to the finger increases, the electronic device 100 may scroll the displayed thumbnail images in a direction of a recently captured image.

When in the third range, the second direction is a direction of the recently captured image.

The first range and the second range may be defined in various manners, such as using an absolute distance from the electronic device 100 to a finger, a size of a recognized finger, etc.

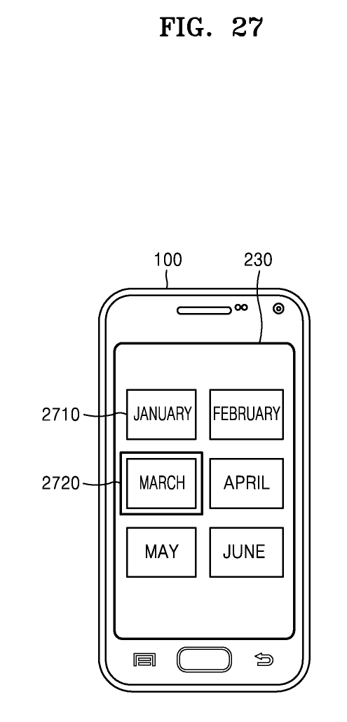

FIG. 27 is a diagram illustrating a method of displaying content objects when changing ranges of displayed content objects, according to an embodiment of the present invention.

Referring to FIG. 27, in changing a range of each of a plurality of displayed content objects, the plurality of content objects may be grouped and displayed by a unit for changing the displayed content objects. For example, when the first finger gesture is recognized and a unit for changing each of a plurality of displayed content objects corresponding to the first finger gesture is a month unit, the electronic device 100 displays, in the display unit 230, a cover 2710 representing the unit for changing each of the displayed content objects, instead of displaying the content objects themselves and changes a selected content object according to a change in a distance to a finger. A selected content object 2720 is displayed in a distinguished form, such as by changing a color of the selected object 2720, moving a selection box, etc.

Alternatively, as illustrated in FIG. 12, the electronic device 100 displays a cover 1220 representing a range of a currently selected or currently displayed content object.

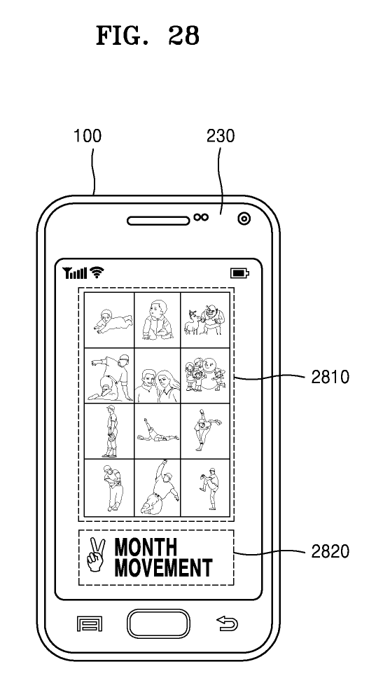

FIG. 28 is a diagram of a screen of an electronic device displayed when changing a range of displayed content objects, according to an embodiment of the present invention.

Referring to FIG. 28, the electronic device 100 displays, on a screen of the display unit 230, a currently recognized finger gesture and information about a unit for changing a displayed content object corresponding to the finger gesture. For example, a plurality of content objects is displayed on a first screen region 2810, and a currently recognized finger gesture and information (month movement) related to a unit for changing a displayed content object corresponding to the finger gesture is displayed on a second screen region 2820.

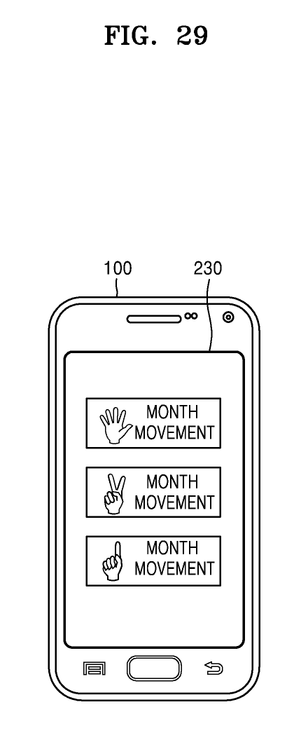

FIG. 29 is a diagram of a finger gesture guide screen of an electronic device, according to an embodiment of the present invention.

Referring to FIG. 29, the electronic device 100 displays a plurality of defined finger gestures and guide information indicating information about a unit for changing displayed content objects corresponding to each of the plurality of defined finger gestures. For example, the defined finger gesture and the information about the change unit are marked on the guide information. The guide information may be displayed in a form of a whole screen, as illustrated in FIG. 29, or may be displayed in a partial region of a screen while displaying the content objects. For example, when a function (for example, a photograph album function, an e-book function, or the like) of using content objects is performed, the guide information may be automatically displayed. As another example, when a signal for requesting guide information is input from a user, the guide information may be displayed.

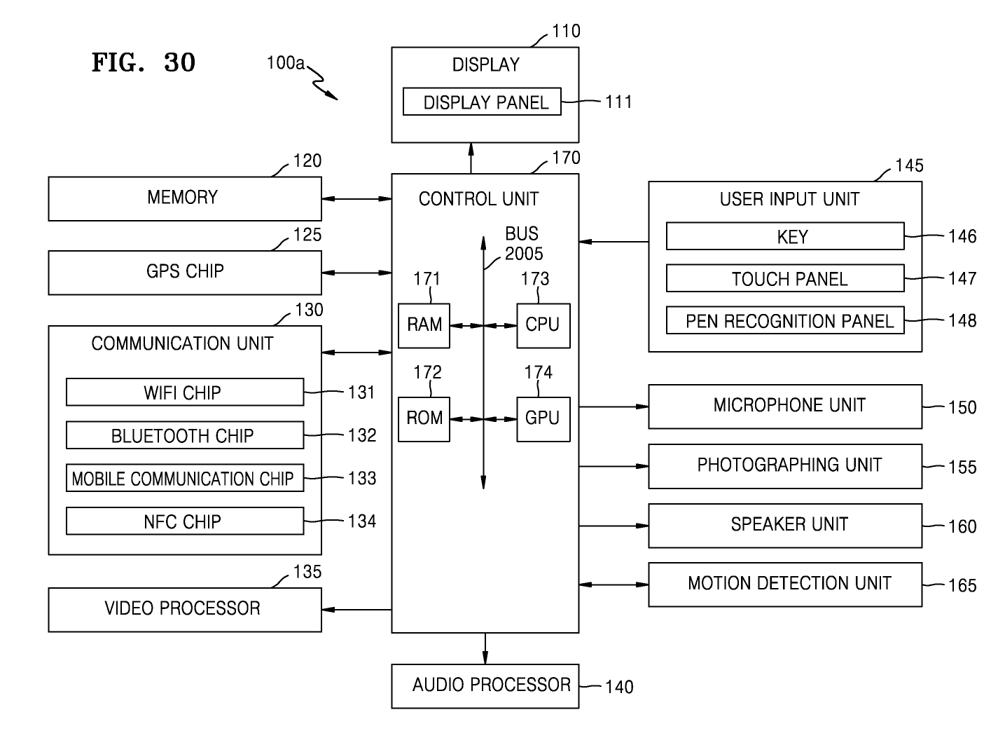

FIG. 30 is a block diagram of a configuration of an electronic device, according to an embodiment of the present invention.

Referring to FIG. 30, the configuration of the electronic device 100a may be applied to, for example, various types of devices such as portable phones, tablet PCs, personal digital assistants (PDAs), MP3 players, kiosks, electronic picture frames, navigation devices, digital TVs, wearable devices such as wrist watches and head-mounted displays (HMDs), etc.

Referring to FIG. 30, the electronic device 100a includes at least one of a display unit 110, a control unit 170, a memory 120, a global positioning system (GPS) chip 125, a communication unit 130, a video processor 135, an audio processor 140, a user input unit 145, a microphone unit 150, an photographing unit 155, a speaker unit 160, and a motion detection unit 165.

The display unit 110 includes a display panel 111 and a controller that controls the display panel 111. The display panel 111 may be implemented as various types of displays such as an LCD, an organic light-emitting diode (OLED) display, an active-matrix organic light-emitting diode (AM-OLED), a plasma display panel (PDP), etc. The display panel 111 may be implemented to be flexible, transparent, or wearable. The display unit 110 may be combined with a touch panel 147 included in the user input unit 145 and, thus, may be provided as a touch screen. For example, the touch screen may include an integrated module where the display panel 111 and the touch panel 147 are combined with each other in a stacked structure.

The memory 120 includes at least one of an internal memory and an external memory.

The internal memory may include at least one of a volatile memory (for example, a dynamic random access memory (DRAM), a static random access memory (SRAM), a synchronous dynamic random access memory (SDRAM), etc.), a nonvolatile memory (for example, a one time programmable read-only memory (OTPROM), a programmable read-only memory (PROM), an erasable and programmable read-only memory (EPROM), an electrically erasable and programmable read-only memory (EEPROM), a mask read-only memory (MROM), a flash read-only memory (FROM), etc.), a hard disk drive (HDD), and a solid state drive (SSD). The control unit 170 loads and processes a command or data, received from at least one of the nonvolatile memory and another element, into a volatile memory. Also, the control unit 170 stores data received from or generated by the other element in the nonvolatile memory.

The external memory includes at least one of compact flash (CF), secure digital (SD), micro-secure digital (micro-SD), mini-secure digital (mini-SD), extreme digital (Xd), memory stick, etc.

The memory 120 stores various programs and data used to operate the electronic device 100a. For example, at least a portion of content to be displayed on a lock screen may be temporarily or semi-permanently stored in the memory 120.

The control unit 170 controls the display unit 110 to display the portion of the content stored in the memory 120. In other words, the control unit 170 displays the portion of the content, stored in the memory 120, on the display unit 110. Additionally, when a user gesture is applied through one region of the display unit 110, the control unit 170 may perform a control operation corresponding to the user gesture.

The control unit 170 includes at least one of a RAM 171, a ROM 172, a central processing unit (CPU) 173, a graphic processing unit (GPU) 174, and a bus 175. The RAM 171, the ROM 172, the CPU 173, and the GPU 174 are connected to each other through the bus 2005.

The CPU 173 accesses the memory 120 to perform booting by using an operating system (OS) stored in the memory 120. Furthermore, the CPU 173 may perform various operations by using various programs, content, data, and/or the like stored in the memory 120.

A command set and/or the like for system booting may be stored in the ROM 172. For example, when a turn-on command is input and power is supplied to the electronic device 100a, the CPU 173 copies the OS, stored in the memory 120, to the RAM 171 and executes the OS to boot a system according to a command stored in the ROM 172. When the booting is completed, the CPU 173 copies various programs, stored in the memory 120, to the RAM 171 and executes the programs copied to the RAM 171 to perform various operations. When booting of the electronic device 100a is completed, the GPU 174 displays a user interface (UI) screen on a region of the display unit 110. In detail, the GPU 174 generates a screen that displays an electronic document including various objects such as content, an icon, a menu, etc. The GPU 174 performs an arithmetic operation on an attribute value such as a form, a size, a color, or a coordinate value where the objects are to be displayed, based on a layout of a screen. Also, the GPU 174 generates a screen of various layouts including an object, based on an attribute value obtained through the arithmetic operation. The screen generated by the GPU 174 is provided to the display unit 110 and is displayed on each of regions of the display unit 110.

The GPS chip 125 may receive a GPS signal from a GPS satellite to calculate a current position of the electronic device 100a. When a navigation program is used or a current position of a user is necessary, the control unit 170 may calculate a user position by using the GPS chip 1

The communication unit 130 communicates with various types of external devices according to various types of communication schemes. The communication unit 130 includes at least one of a Wi-Fi chip 131, a Bluetooth chip 132, a wireless communication chip 133, and a near field communication (NFC) chip 134. The control unit 170 communicates with various external devices by using the communication unit 130.

The Wi-Fi chip 131 and the Bluetooth chip 132, respectively, perform communication in a Wi-Fi scheme and a Bluetooth scheme. In a case of using the Wi-Fi chip 131 or the Bluetooth chip 132, various pieces of connection information such as an SSID, a session key, etc. are first transmitted or received, a communication connection is made by using the connection information, and various pieces of information are transmitted or received.

The wireless communication chip 133 refers to a chip that performs communication according to various communication standards such as IEEE, zigbee, 3rd generation (3G), 3rd generation partnership project (3GPP), long term evolution (LTE), etc.

The NFC chip 134 refers to a chip that operates in an NFC scheme using a band of 13.56 MHz among various radio frequency-identification (RF-ID) frequency bands such as 135 kHz, 13.56 MHz, 433 MHz, 860 to 960 MHz, 2.45 GHz, etc.

The video processor 135 processes video data included in content received through the communication unit 130 or in content stored in the memory 120. The video processor 135 performs various image processing functions, such as decoding, scaling, noise filtering, frame rate conversion, resolution conversion, and/or the like, for video data.

The audio processor 140 processes audio data included in the content received through the communication unit 130 or in the content stored in the memory 120. The audio processor 140 performs various processing such as decoding, amplification, noise filtering, and/or the like for the audio data.

When a reproduction program for multimedia content is executed, the control unit 170 drives the video processor 135 and the audio processor 140 to reproduce corresponding content.

The speaker unit 160 may output the audio data generated by the audio processor 140.

The user input unit 145 receives various commands from a user. The user input unit 145 includes at least one of a key 146, a touch panel 147147, and a pen recognition panel 148.

The key 146 includes various types of keys such as a mechanical button, a wheel, etc. disposed in various regions such as a front part, a side part, a rear part, etc. of a body of the electronic device 100a.

The touch panel 147 senses a touch input of the user and outputs a touch event value corresponding to the sensed touch signal. When the touch panel 147 is combined with the display panel 111 to configure a touch screen, the touch screen may be implemented with various types of touch sensors such as a capacitive touch sensor, a pressure sensitive touch sensor, a piezoelectric touch sensor, etc. A capacitive type is a method that, by using dielectric coated on a surface of a touch screen, senses fine electricity which is applied to a user body when a part of the user's body touches the surface of the touch screen, and calculates touch coordinates by using the sensed electricity. A pressure sensitive type is a method that, by using two electrode plates (an upper plate and a lower plate) built into a touch screen, senses a current that is generated by a contact between the upper plate and the lower plate at a touched position when a user touches a screen, and calculates touch coordinates by using the sensed current. A touch event occurring in a touch screen is generally generated by a person's finger, but may be generated by an object including a conductive material for changing a capacitance.

The pen recognition panel 148 senses a pen proximity input or a pen touch input which is applied thereto by a touch pen (for example, a stylus pen), a digitizer pen, etc., and outputs a sensed pen proximity event or a pen touch event. The pen recognition panel 148 may be implemented in, for example, an EMR type. The pen recognition panel 148 senses a touch or proximity input, based on an intensity change of an electromagnetic field generated by a proximity or a touch of a pen. In detail, the pen recognition panel 148 includes an electronic signal processing unit that sequentially supplies an alternating current (AC) signal having a certain frequency to an electronic induction coil sensor having a grid structure and a loop coil of the electronic induction coil sensor. When a pen with a built-in resonance circuit is located near the loop coil of the pen recognition panel 148, a magnetic field transmitted from the loop coil generates a current based on mutual electronic induction in the resonance circuit of the pen. An inductive magnetic field is generated from a coil configuring the resonance circuit of the pen, based on the current. The pen recognition panel 148 detects the inductive magnetic field in the loop coil which is in a state of receiving a signal, and senses a proximity position or a touch position of the pen. The pen recognition panel 148 may be provided to have a certain area (for example, an area for covering a display area of the display panel 111) at a lower portion of the display panel 111.

The microphone unit 150 receives user voice or other sound and converts the received voice or sound into audio data. The control unit 170 uses the user voice, input through the microphone unit 150, in a call operation or converts the user voice into the audio data to store the audio data in the memory 120.

The photographing unit 155 captures a still image or a moving image according to control by the user. The photographing unit 155may be provided in plurality like a front camera, a rear camera, etc.

When the photographing unit 155 and the microphone unit 150 are provided, the control unit 170 performs a control operation according to a user voice, which is input through the microphone unit 150, or a user motion recognized by the photographing unit 155. For example, the electronic device 100a operates a motion control mode or a voice control mode. When the electronic device 100a operates in the motion control mode, the control unit 170 activates the photographing unit 155 to allow the photographing unit 155 to photograph the user and traces a motion change of the user to perform a control operation corresponding to the motion change. When the electronic device 100a operates in the voice control mode, the control unit 170 analyzes the user voice input through the microphone unit 150 and operates in a voice recognition mode of performing a control operation according to the analyzed user voice.

The motion detection unit 165 senses a movement of the electronic device 100a. The electronic device 100a may be rotated or inclined in various directions. In this case, the motion detection unit 165 senses movement characteristics such as a rotation direction, a rotated angle, a slope, etc. by using at least one of various sensors such as a geomagnetic sensor, a gyro sensor, an acceleration sensor, and/the like.

In addition, the electronic device 100a may further include a universal serial bus (USB) connectable to a USB connector, various external input ports connectable to various external devices such as a headset, a mouse, a local area network (LAN), etc., a digital multimedia broadcasting (DMB) chip that receives and processes a DMB signal, and/or various sensors.

Names of the above-described elements of the electronic device 100a may be changed. Also, the electronic device 100a may be configured with at least one of the above-described elements. However, some elements may be omitted, or the electronic device 100a may further include another element.

The methods of the present invention may be implemented as computer-readable codes in non-transitory computer-readable recording media. The non-transitory computer-readable recording media includes all kinds of recording devices that store data readable by a computer system.

The computer-readable codes may be implemented to perform operations of the electronic device control method according to an embodiment of the present invention when the codes are read from the non-transitory computer-readable recording medium and executed by a processor. The computer-readable codes may be implemented using various programming languages. Functional programs, codes, and code segments for implementing the embodiments may be easily programmed by one of ordinary skill in the art.

Examples of the non-transitory computer-readable recording medium include read-only memory (ROM), random-access memory (RAM), CD-ROMs, magnetic tapes, floppy disks, optical data storage devices, etc. The computer-readable recording medium may also be distributed over network coupled computer systems so that the computer-readable code is stored and executed in a distributed fashion.

According to the embodiments of the present invention, when a plurality of content objects is being displayed, a user may easily change the displayed content objects. Moreover, when a user changes content objects to be displayed, the number of manipulations necessarily performed by the user is reduced.

It should be understood that various embodiments described herein should be considered in a descriptive sense only and not for purposes of limitation. Descriptions of features or aspects within each embodiment should typically be considered as available for other similar features or aspects in other exemplary embodiments.

While one or more embodiments have been described with reference to the figures, it will be understood by those of ordinary skill in the art that various changes in form and details may be made therein without departing from the spirit and scope as defined by the following claims and their equivalents.

What is claimed is:

1. An electronic device comprising:
a photographing unit configured to photograph a hand including fingers;
a display unit configured to display a plurality of content objects; and
a control unit configured to:
recognize a finger gesture of the photographed hand and a distance from the electronic device to the fingers, and
control the display unit to change and display a range of a displayed content object according to the recognized finger gesture and the distance.

2. The electronic device of claim 1, wherein the finger gesture is determined based on a combination of a folded finger and an opened finger.

3. The electronic device of claim 1, wherein the control unit is further configured to, when the recognized distance is changed in a state of maintaining the recognized finger gesture, change the range of the displayed content object.

4. The electronic device of claim 1, wherein
the plurality of content objects each comprise a plurality of thumbnail images for reproducing image data when selected,
an order of the plurality of content objects is determined based on a photograph date of image data corresponding to each of the plurality of thumbnail images, and
the control unit is further configured to, when changing the range of the displayed content object, determine a unit of change for changing the order of the plurality of content objects from among a year unit, a month unit, and a day unit, based on the recognized finger gesture, and change an order of the plurality of thumbnail images, displayed by the display unit, by the unit of change according to the recognized distance.

5. The electronic device of claim 4, wherein the unit of change of the range of the displayed content object corresponding to each of a plurality of finger gestures is determined based on a user input.

6. The electronic device of claim 1, wherein the display unit is further configured to display information about a unit of change of the range of the displayed content object corresponding to the recognized finger gesture.

7. The electronic device of claim 1, wherein the display unit is further configured to display a plurality of recognizable finger gestures and information about a unit of change of the range of the displayed content object corresponding to each of the plurality of recognizable finger gestures.

8. The electronic device of claim 1, wherein the control unit is further configured to, when the recognized finger gesture corresponds to a pre-stored termination finger gesture, control the display unit to terminate changing he range of the displayed content object.

9. The electronic device of claim 1, wherein the control unit is further configured to, when the recognized distance is outside a threshold range, control the display unit to terminate changing the range of the displayed content object.

10. The electronic device of claim 1, wherein content corresponding to the plurality of content objects includes at least one of music content, still image content, moving image content, e-book content, e-mail content, and schedule content.

11. An electronic device control method comprising:
displaying a plurality of content objects;
photographing a hand including fingers;
recognizing a finger gesture of the photographed hand and a distance from the electronic device to the fingers; and
changing a range of a displayed content object according to the recognized finger gesture and the distance.

12. The electronic device control method of claim 11, wherein the finger gesture is determined based on a combination of a folded finger and an opened finger.

13. The electronic device control method of claim 11, wherein changing the range comprises, when the recognized distance is changed in a state of maintaining the recognized finger gesture, changing the range of the displayed content object.

14. The electronic device control method of claim 11, wherein
the plurality of content objects each comprise a plurality of thumbnail images for reproducing image data when selected,
an order of the plurality of content objects is determined based on a photograph date of image data corresponding to each of the plurality of thumbnail images, and
changing the range comprises, when changing and displaying the range of the displayed content object, determining a unit of change for changing the order of the plurality of content objects from among a year unit, a month unit, and a day unit, based on the recognized finger gesture, and changing an order of the plurality of thumbnail images displayed by the unit of change according to the recognized distance.

15. The electronic device control method of claim 14, wherein the unit of change of the range of the displayed content object corresponding to each of a plurality of finger gestures is determined based on a user input.

16. The electronic device control method of claim 11, further comprising displaying information about a unit of change of the range of the displayed content object corresponding to the recognized finger gesture.

17. The electronic device control method of claim 11, further comprising displaying a plurality of recognizable finger gestures and information about a unit of change of the range of the displayed content object corresponding to each of the plurality of recognizable finger gestures.

18. The electronic device control method of claim 11, further comprising, when the recognized finger gesture corresponds to a pre-stored termination finger gesture, terminating changing the range of the displayed content object.

19. The electronic device control method of claim 11, further comprising, when the recognized distance is outside a threshold range, terminating changing the range of the displayed content object.

20. The electronic device control method of claim 11, wherein content corresponding to the plurality of content objects includes at least one of music content, still image content, moving image content, e-book content, e-mail content, and schedule content.

21. A non-transitory computer-readable recording storage medium having stored thereon a computer program which, when executed by a computer, performs the method of claim 11.
